(19) United States
(12) Patent Application Publication
(10) Pub. No.: US 2014/0225995 A1
(43) Pub. Date: Aug. 14, 2014

(54) METHOD FOR CROSSTALK CORRECTION FOR 3D PROJECTION

(71) Applicant: THOMSON LICENSING, Issy de Moulineaux (FR)

(72) Inventors: William Gibbens Redmann, Glendale, CA (US); Mark J. Huber, Burbank, CA (US); Jed Harmsen, Los Angeles, CA (US)

(73) Assignee: THOMSON LICENSING, Issy de Moulineaux (FR)

(21) Appl. No.: 14/345,817

(22) PCT Filed: Oct. 3, 2012
(86) PCT No.: PCT/US2012/058549

§ 371 Date: Mar. 19, 2014

Related U.S. Application Data
(60) Provisional application No. 61/542,795, filed on Oct. 3, 2011.

(51) Int. Cl. H04N 13/04

(52) U.S. Cl. CPC H04N 13/0425; H04N 13/0459
USPC 348/51

(57) ABSTRACT

A method and system are disclosed for producing a crosstalk-compensated film or digital image file for use in stereoscopic presentation. Expected crosstalks for all pixels in respective first and second images of a stereoscopic image pair are determined based on brightness measurements obtained for projected first and second test images. A crosstalk-compensated film or digital image file can be produced with pixel values or film densities adjusted for all pixels based on the expected crosstalks.

### CROSS-REFERENCES TO OTHER APPLICATIONS

This application claims priority to U.S. provisional application Ser. No. 61/542,795, “Method and System for Crosstalk Correction for 3-Dimensional (3D) Projection” filed on Oct. 3, 2011, which is herein incorporated by reference in its entirety.

### TECHNICAL FIELD

The invention relates to a method and system for producing a film or digital image file with crosstalk compensation, and to a crosstalk-compensated film or digital image file.

### BACKGROUND

The increasing popularity of 3D films is made possible by the ease of use of 3D digital cinema projection systems. However, the rate of rollout of those systems is not adequate to keep up with demand, and is further a very expensive approach to obtaining 3D. Earlier 3D film systems were besieged by difficulties, including mis-configuration, low brightness, and discoloration of the picture, but are considerably less expensive than the digital cinema approach. It is therefore desirable to provide a high-quality film-based 3D presentation that has a quality sufficient to attract audiences to the same degree that digital cinema 3D does by improving the image separation, color, and brightness to compete with, if not exceed, that of the digital cinema presentations.

Prior single-projector 3D film systems use a dual lens to simultaneously project left- and right-eye images laid out above and below each other on the same strip of film (also referred to as an “over-and-under” lens, in which an upper lens projects an image for one eye, and a lower lens projects an image for the other eye). These left- and right-eye images are separately encoded (e.g., by distinct polarization or chromatic filters) and projected together onto a screen and are viewed by an audience wearing filter glasses that act as decoders, such that the audience's left eye sees primarily the projected left-eye images, and the right eye sees primarily the projected right-eye images.

However, imperfection in one or more components in the projection and viewing system, e.g., encoding and decoding filters, projection screen, can result in a certain amount of light for projecting right-eye images becoming visible to the audience's left eye, and vice versa (e.g., a linear polarizing filter in a vertical orientation can pass some horizontally polarized light, or a screen may depolarize a small fraction of light scattering from it), resulting in crosstalk. “Crosstalk” can generally be used to refer to the phenomenon or behavior of light leakage in a stereoscopic projection system, resulting in a projected image being visible to the wrong eye.

The binocular disparities that are characteristic of stereoscopic imagery put objects to be viewed by the left- and right-eyes at horizontally different locations on the screen (and the degree of horizontal separation determines the perception of distance). The effect of crosstalk, when combined with a binocular, disparity, is that each eye sees a bright image of an object in the correct location on the screen, and a dim image (or dimmer than the other image) of the same object at a slightly offset position, resulting in a visual “echo” or “ghost” of the bright image.

The projected left- and right-eye images from these prior art “over-and-under” projection systems also exhibit a differential keystoning effect, in which the two images have different geometric distortions. This is because if the projector is located higher than the horizontal centerline of the screen, the upper lens (typically corresponding to the right-eye image), is higher above the bottom of the screen than is the lower lens (corresponding to the left-eye image) and so has a greater throw to the bottom of the screen, resulting in the right-eye image near the bottom of the screen undergoing a greater magnification than the left-eye image. Similarly, the left-eye image (projected through the lower lens) undergoes a greater magnification at the top of the screen than does the right-eye image.

These keystone errors detract from the 3D presentation, since in the configuration described, the differential keystoning produces two detrimental effects:

First, in the top-left region of the screen, the greater-magnified left-eye image appears more to the left than the lesser-magnified right-eye image. This corresponds in 3D to objects in the image being farther away. The opposite takes place in the top-right region, where the greater-magnified left-eye image appears more to the right and, since the audience's eyes are more converged as a result, the objects there appear nearer. For similar reasons, the bottom-left region of the screen displays objects closer than desired, and the bottom-right region displays objects farther away than desired. The overall depth distortion is rather potato-chip-like, or saddle shaped, with one pair of opposite corners seeming to be farther away, and the other pair seeming nearer.

Second, differential keystoning causes a vertical misalignment between the left- and right-eye images near the top and bottom of the screen, which can cause fatigue when viewed for a long time.

The presence of differential keystoning further modifies the positions of the crosstalking images, beyond merely the binocular disparity. Not only is the combined effect distracting to audiences, but it can also cause eye-strain, and detracts from the 3D presentation.

In present-day stereoscopic digital projection systems, pixels of a projected left-eye image are precisely aligned with pixels of a projected right-eye image because both projected images are being formed on the same digital imager, which is time-domain multiplexed between the left- and right-eye images at a rate sufficiently fast as to minimize the perception of flicker. Crosstalk contribution from a first image to a second image can be compensated for by reducing the luminance of a pixel in the second image by the expected crosstalk from the same pixel in the first image. It is also known that this crosstalk correction can vary chromatically, e.g., to correct a situation in which the projector's blue primary exhibits a different amount of crosstalk than green or red, or spatially, e.g., to correct a situation in which the center of the screen exhibits less crosstalk than the edges.

For example, a technique for crosstalk compensation in digital projection systems is taught in US published patent application US2007/0188602 by Cowan, which subtracts from the image for one eye a fraction of the image for the other eye, where the fraction corresponds to the expected crosstalk. This works in digital cinema (and video) because these systems do not exhibit differential keystone distortion, and the left- and right-eye images overlay each other precisely.

However, for stereoscopic film-based or digital projection systems such as a dual-projector system (two separate projectors for projecting left- and right-images, respectively) or single-projector dual lens system, a different approach has to be used for crosstalk compensation to take into account of differential distortions between the two images of a stereoscopic pair.

### SUMMARY OF THE INVENTION

Various aspects of the present invention relate to at least one method for characterizing crosstalks associated with a projection system for stereoscopic projection, and for producing a film or digital image file with crosstalk compensation based on crosstalks determined using the method.

One embodiment of the present invention provides a method for producing one of a crosstalk-compensated stereoscopic film or digital image data for use with a projection system. The method includes: (a) projecting a first image of a stereoscopic test image pair on a screen and measuring brightness at one or more locations on the screen; (b) projecting a second image of the stereoscopic test image pair on the screen and measuring brightness at one or more locations on the screen; (c) for each pixel of the stereoscopic test image pair, determining a crosstalk related to the projection system based at least on the brightness measurements from steps (a) and (b); and (d) producing at least one of the stereoscopic film or digital image data, each with pixel adjustments based at least on the system-related crosstalk at each pixel of the stereoscopic test image pair.

### BRIEF DESCRIPTION OF THE DRAWINGS

The teachings of the present invention can be readily understood by considering the following detailed description in conjunction with the accompanying drawings, in which:

FIG. 1 is a drawing of a stereoscopic film projection system using a dual (over-and-under) lens projector;

FIG. 2 illustrates the projection of left- and right-eye images projected with the stereoscopic film projection system of FIG. 1;

FIG. 3 is a 3D graph showing the gradient of illumination relative to the opening in aperture plate;

FIG. 4 is a 2D graph showing an example of differential brightness: the differing profiles of the brightness of the right- and left-eye image illumination along the vertical centerline of screen;

FIG. 5 is a 2D graph of the variation in crosstalk along the vertical centerline of the screen, resulting from the differential brightness shown in FIG. 4;

FIG. 6 shows a spatial relationship between a pixel from a first image of a stereoscopic pair and proximate pixels from a second image of the stereoscopic pair that may contribute to crosstalk at the pixel of the first image when projected;

FIG. 7 illustrates a process for compensating for crosstalk at each pixel based on the leakage of a projection system and brightness measurements;

FIG. 8 illustrates a process for compensating for crosstalk at each pixel based on brightness measurements;

FIG. 9 illustrates a process for compensating for crosstalk based on brightness measurements;

FIG. 10 illustrates various luminance parameters associated with a projected stereoscopic image pair; and

FIG. 11 illustrates a digital stereoscopic projector system suitable for use with the present invention.

To facilitate understanding, identical reference numerals have been used, where possible, to designate identical elements that are common to the figures. The drawings are not to scale, and one or more features may be expanded or reduced for clarity.

### DETAILED DESCRIPTION

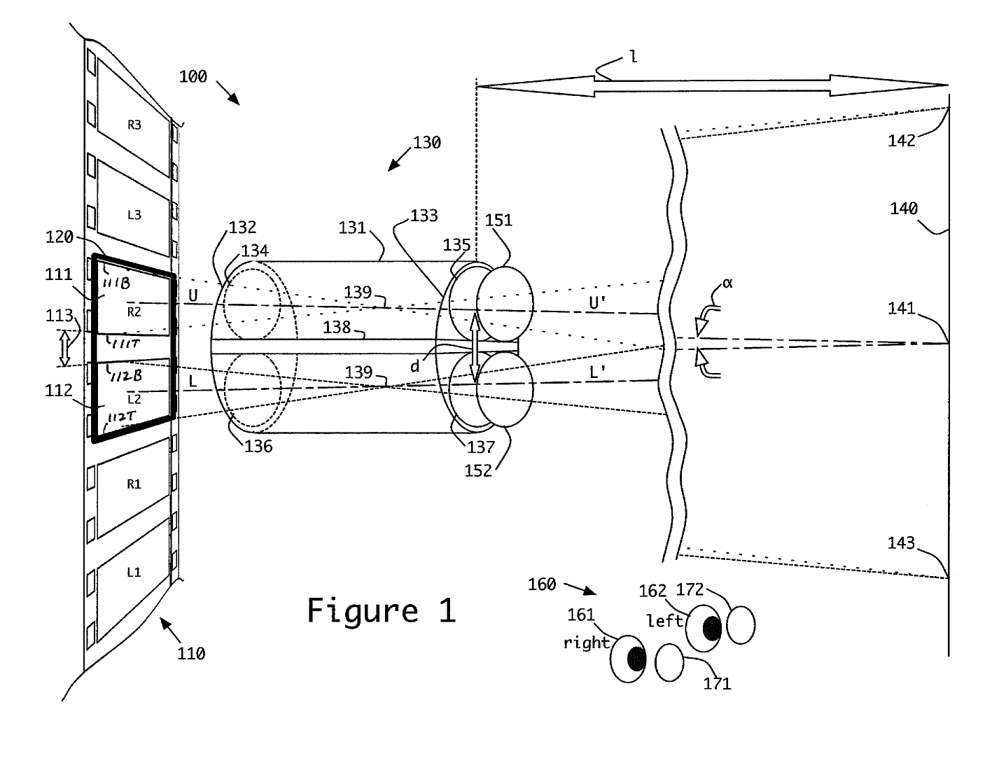

FIG. 1 shows an over/under lens 3D or stereoscopic film projection system 100, also called a dual-lens 3D film projection system. Rectangular left-eye image 112 and corresponding rectangular right-eye image 111, both on over/under 3D film 110, are simultaneously illuminated by a light source and condenser optics (collectively called the “illuminator”, not shown) located behind the film while framed by aperture plate 120 (of which only the inner edge of the aperture is illustrated, for clarity) such that all other images on film 110 are not visible since they are covered by the portion of the aperture plate which is opaque. The corresponding left- and right-eye images (forming a stereoscopic image pair) visible through aperture plate 120 are projected by over/under lens system 130 onto screen 140, generally aligned and superimposed such that the tops of both projected images are aligned at the top edge 142 of the screen viewing area, and the bottoms of the projected images are aligned at the bottom edge 143 of the screen viewing area.

Over/under lens system 130 includes body 131, entrance end 132, and exit end 133. The upper and lower halves of lens system 130, which can be referred to as two lens assemblies, are separated by septum 138, which prevents stray light from crossing between the two lens assemblies. The upper lens assembly, typically associated with right-eye images (i.e., used for projecting right-eye images such as image 111), has entrance lens 134 and exit lens 135. The lower lens assembly, typically associated with left-eye images (i.e., used for projecting left-eye images such as image 112), has entrance lens 136 and exit lens 137.

Aperture stops 139 internal to each half of dual lens system 130 are shown, but for clarity's sake other internal lens elements are not. Additional external lens elements, e.g., a magnifier following the exit end of dual lens 130, may also be added when appropriate to the proper adjustment of the projection system 100, but are also not shown in FIG. 1. Projection screen 140 has viewing area center point 141 at which the projected images of the two film images 111 and 112 should be centered.

The left- and right-eye images 112 and 111 are projected through left- and right-eye encoding filters 152 and 151 (may also be referred to as projection filters), respectively. To view the stereoscopic images, an audience member 160 wears a pair of glasses with appropriate decoding or viewing filters or shutters such that the audience's right eye 161 is looking through right-eye decoding filter 171, and the left eye 162 is looking through left-eye decoding filter 172. Left-eye encoding filter 152 and left-eye decoding filter 172 are selected and oriented to allow the left eye 162 to see only the projected left-eye images on screen 140, but not the projected right-eye images. Similarly, right-eye encoding filter 151 and right-eye decoding filter 171 are selected and oriented to allow right eye 161 to see only the projected right-eye images on screen 140, but not left-eye images.

Examples of filters suitable for this purpose include linear polarizers, circular polarizers, anaglyphic (e.g., red and blue), and interlaced interference comb filters, among others. Active shutter glasses, e.g., using liquid crystal display (LCD) shutters to alternate between blocking the left or right eye in synchrony with a similarly-timed shutter operating to extinguish the projection of the corresponding film image, are also feasible.

Unfortunately, due to physical or performance-related limitations of filters 151, 152, 171, 172, and in some cases, screen 140 and the geometry of projection system 100, a non-zero amount of crosstalk can exist, in which the projected left-eye images are slightly visible, i.e., faintly or at a relatively low intensity, to the right-eye 161 and the projected right-eye images are slightly visible to the left-eye 162.

This crosstalk results in a slight double image for some of the objects in the projected image. This double image is at best distracting and at worst can inhibit the perception of 3D. Its elimination is therefore desirable.

In one embodiment, the filters 151 and 152 are linear polarizers, e.g., an absorbing linear polarizer 151 having vertical orientation placed after exit lens 135, and an absorbing linear polarizer 152 having horizontal orientation placed after exit lens 137. For purpose of this discussion, the vertical and horizontal polarization orientations (or clockwise and counter-clockwise circular polarizations in other embodiments) may be referred to as being orthogonal or opposite orientations. Screen 140 is a polarization preserving projection screen, e.g., a silver screen. Audience's viewing glasses includes a right-eye viewing filter 171 that is a linear polarizer with a vertical axis of polarization, and a left-eye viewing filter 172 that is a linear polarizer with a horizontal axis of polarization (i.e., each viewing filter or polarizer in the glasses has the same polarization orientation as its corresponding filter or polarizer 151 or 152 associated with the respective stereoscopic image). Thus, the right-eye image 111 projected through the top half of dual lens 130 becomes vertically polarized after passing through filter 151, and the vertical polarization is preserved as the projected image is reflected by screen 140. Since the vertically-polarized viewing filter 171 has the same polarization as the projection filter 151 for the right-eye image, the projected right-eye image 111 can be seen by the audience's right-eye 161. However, the projected right-eye image 111 would be substantially blocked by the horizontally-polarized left-eye filter 172 so that the audience's left-eye 162 would not see the projected right-eye image 111. Unfortunately, the performance characteristics of such filters are not always ideal, and leakage can result from their non-ideal characteristics.

Usually, leakage is related to an intrinsic property of a material, and arises from imperfections and/or non-ideal properties in one or more components in the optical path, e.g., filters (encoders at the projector end and decoders on the audience's glasses) and other elements, including the screen. For example, a linear polarizer in a vertical orientation that transmits a non-zero fraction of horizontally polarized light, or a projection screen that depolarizes a non-zero fraction of scattered light, is said to exhibit leakage. Thus, each element or component of a stereoscopic system may have its own leakage contribution, and these leakage contributions combine to give the total leakage exhibited by the system.

As used herein, leakage of the light used for projecting a first eye's image (i.e., leakage from the first eye's image into the second eye), is defined as the ratio of the amount of light for projecting the first image seen by the second eye, i.e., wrong eye, to the amount of light for projecting the first image seen by the first eye, i.e., correct eye. Thus, if I_{R} is the amount of light provided by the upper half of the lens for projecting the right-eye image, and the amount of light reaching the left eye is given by y(I_{R}) and that reaching the right eye is given by x(I_{R}), then the leakage from the right-eye image to the left eye is given by y/x, where x and y are numbers ranging from zero to one, and y is less than x (i.e., 0≦y<x≦1). In general, the projection optics are designed and configured so that y is much less than x, e.g., so that the left eye sees primarily the left-eye image.

In this example, leakage of the projected right-eye image into the left-eye 162 of audience member 160 is a function of three first-order factors: first, the amount by which right-eye encoding filter 151 (oriented to transmit primarily vertically polarized light) transmits horizontally polarized light; second, the degree to which screen 140 fails to preserve the polarization of light it reflects; and third, the amount by which left-eye decoding filter 172 (oriented to transmit primarily horizontally polarized light) transmits vertically polarized light used for projecting right-eye images.

These factors are measurable physical values or quantities that affect the entire image, in some cases approximately equally throughout the entire screen. However, there are variations that can be measured across the screen (e.g., the degree to which polarization is maintained may vary with angle of incidence or viewing angle, or both), or at different wavelengths (e.g., a polarizer may exhibit more transmission of the undesired polarization in the blue portion of the spectrum than in the red). Since the crosstalk or leakage arises from one or more components of the projection system, they can be referred to as being associated with the projection system, or with the projection of stereoscopic images. Other factors such as an audience member's improper orientation of viewing glasses, or non-optimal operating conditions of filters and/or screen (e.g., due to overheating or dirty components) can also affect leakage or crosstalk.

For some systems, one or more of the possible sources of crosstalk may not apply. For instance, in an embodiment where the projected right- and left-eye images are spectrally encoded by using different wavelengths (instead of using different polarizations) of light for projecting the right- and left-eye images, screen 140 does not need to be polarization preserving, and will likely not contribute to crosstalk if the screen 140 transmits different wavelengths with equal efficiencies and does not affect light transmission through the viewing filters.

Leakage in a system is often substantially uniform or spatially invariant. In some projection systems, however, the leakage can have a geometric or spatial dependence. For example, the leakage of a particular frequency of light through an interference filter (used as a viewing filter) is a function of the angle of incidence. Thus, a particular frequency of light scattered from the center of the screen will encounter the viewing filters of an audience member at an angle of incidence that is different from the light scattered from an edge of the screen, and the leakages associated with the light from the center and edge of the screen will be different. In another example, a screen material may preserve polarization, and thus, exhibit low leakage, for close to normal incidence and reflection or scattering angles, but increased leakage for larger angles of incidence and reflection or scattering.

If variations in leakage cannot be characterized as a fixed value for a given pixel (or, if uniform, as a fixed value for the system), e.g., if the leakage varies by seating within a theatre, or as an audience member's head is turned towards different portions of the screen, then the best choice is to compensate for crosstalk based on a mean or reference leakage value, which may, for example, be defined for an audience member in the middle of the seating area, and generally looking towards the center of the screen. In some cases, a reference seat might be chosen to be other than the center seat, if it were the case that there was variation in the leakage dependent upon viewing angle, so that the outer seats might be under compensated and the central seats overcompensated, but the standard deviation minimized.

Although leakage from the right eye image to the left eye is often about the same as the leakage from the left eye image to the right eye (referred to as “symmetrical”), there are situations in which the leakages are different. For example, in a system that uses an electronic shutter to determine the image seen by each eye based on timing of the shutter, an asymmetrical timing error can result in different leakages for the two images. Such “asymmetric” leakages can also occur for other types of projection and/or viewing filters with different transmissive properties for the right- and left-eye images. While the resulting asymmetric leakage can be addressed by the present principles, for simplicity's sake, examples below assume symmetrical leakage for the projected left- and right-eye images.

Crosstalk occurs as a result of leakage. As used herein, “crosstalk” for a first eye, i.e. arising from light leakage from a second-eye image into the first eye, is the ratio of the brightness of the projected second-eye image as seen by the first eye to the brightness of the projected first-eye image as seen by the first eye. If a system's leakage is zero, the brightness of the projected second-eye image as seen by the first eye would be zero, and crosstalk will also be zero. Furthermore, the crosstalk at a particular point on the screen will be proportional to the leakage at that point on the screen. However, leakage is not the sole determinant, because the presence of other optical distortions or effects (e.g., differential keystoning, or non-uniform illumination of the two stereoscopic images) may lead to crosstalk variations as a function of other parameters. Thus, a crosstalk compensation method may need to take into account these other optical distortions or effects, as further discussed below in various examples.

As previously mentioned, the presence of differential keystoning further modifies the position of the stereoscopic images, thus adding complexity to the estimation or compensation of crosstalk, beyond merely the binocular disparity.

Different aspects of these problems have been addressed elsewhere. For example, US published patent application, US 2011/0032340 A1, “Method for Crosstalk Correction for Three-Dimensional (3D) Projection,” teaches a method of crosstalk correction that takes into account the differential keystoning distortions. In that case, correction is done only for crosstalk, but not for the differential distortion. Another published patent application, US 2011/0007278 A1, “Method and System for Differential Distortion Correction for Three-Dimensional (3D) Projection,” teaches compensation in the image for the differential keystoning. Yet another published patent application, US 2011/038042 A1, “Method and System for Crosstalk and Distortion Corrections for three-Dimensional (3D) Projection,” teaches a method for correcting for crosstalk, where there is the expectation that compensation will be provided to correct most, if not all, of the differential distortion, so that the crosstalk compensation for a first eye's image is derived from pixels from the other eye's image in the same region. Subject matter of these patent applications are herein incorporated by reference in their entireties, and one or more features or approaches described in these patent applications can be used, as appropriate or desired, in conjunction with those of the present invention.

Another effect that may affect crosstalk, and lead to crosstalk variations across the screen, is differential illumination between the left- and right-eye images.

Unequal illumination between the projected left- and right-eye images typically results from a combination of three properties of the projection system:

1) the brightest region of illumination at the film gate in a well-aligned projection system is substantially centered in the gate (or in the case of a digital projector, the center of the imager) with a concentric, symmetrical fall-off;
2) the over-and-under arrangement of the right- and left-eye images in the film gate; and
3) the dual projection lens that causes the right- and left-eye images to be superimposed on the projection screen. The resulting differential illumination is especially egregious at the top and bottom of the screen.

In an alternative embodiment (not shown), filters 151, 152, 171 and 172 may separate the projections of the right- and left-eye images based on another property of light (not polarization), e.g. color or wavelength, which may be reflected differently by screen 140 for the two stereoscopic images. For example, if a particular spectral band is used only in the projection of the left-eye image, and that band is reflected only weakly by screen 140, the left-eye image could be differentially less bright (compared to the right-eye image) as a result.

Compensation for the effect of different illumination is taught in US published patent application, US 2011/007132 A1, “Method and System for Brightness Correction for Three-Dimensional (3D) Projection”, whose subject matter is herein incorporated by reference in its entirety. The present principles apply to situations where such compensation for differential illumination is not performed, or is incomplete or inadequate (i.e., the compensation applied is only a fraction of the compensation needed, or is limited to only a portion of each image).

The effect of leakage and differential illumination at a point on the projection screen is cumulative and results in crosstalk that varies across the screen, as explained below.

If two images are projected, each having the same brightness (i.e., the differential illumination is zero), by an illustrative system having a uniform and symmetric leakage of 10%, then the leakage from a white, or any non-black, object in the first eye image viewed by the second eye will be about 1/10 as bright as the same object viewed by the first eye. For simplicity, it is assumed that leakage is the same for different colors such that leakage in the red, blue and green are all equal to 10%© in this example. These values can be obtained by projecting the white object in the first eye image and measuring the light exiting the respective viewing filters for the second and first images, e.g., HI, (foot-Lambert) exiting the second eye viewing filter, and about 10 fL exiting the first eye viewing filter. Similarly, due to the symmetric leakage, 10 fL of the object in the second eye image is seen by the second eye, while 1 fL is seen by the first eye. Since both images have equal illumination, the crosstalk (for either eye) is also the same as the leakage, i.e., 10%, since the ratio of the first-eye view of the second-eye image (1 fL) to the second-eye view of the second-eye image (10 fL) is 1/10.

However, if there is a differential brightness in projecting the first and second images, such that (at least in the region of the screen under study) the first-eye image is being shown twice as bright as the second-eye image, then from the point of view of the second eye, the 10%© leakage of the first-eye image into the second eye results in 2 fL of the first eye image. Since the second eye image is still projected at the same brightness, the second eye still sees 10 μL of the second image. Therefore, the second eye sees a crosstalk of 2/10 or 20%.

Further, in the presence of differential illumination, crosstalk is not symmetrical from one eye to the other. Since the brightness of the second-eye image as viewed by the first eye (with 10% leakage from the second-eye image) is unchanged at 1 fL, but the brightness of the first-eye image seen by the first eye is 20 fL, the crosstalk from the second-eye image to the first eye is 1/20 or 5%. Note that the differential illumination, in this case 2:1 for the first-eye image to the second-eye image, results in the crosstalk to the second eye being doubled, but crosstalk to the first eye being halved. In other words, the effect of differential illumination on crosstalk for one eye is the reciprocal or inverse of the effect on crosstalk for the other eye.

Thus, in the presence of differential illumination, e.g., a given region in the first image is brighter than the corresponding region in the second image, the brighter region in the first image will produce a ghosting effect for the other (second) eye. Correspondingly, the same region in the second image produces a less significant ghosting effect for the other (first) eye. Regardless of image content, at any point on the screen, the amount of light that leaks from the projection of one eye's image to be viewed by the other eye is proportional to the luminance or brightness of the projection system at that point. Furthermore, any differential illumination between the right- and left-eye images at a region of the screen will also affect the amount of crosstalk. Aside from producing a disturbing visual effect, the differential luminance causes the amount of crosstalk to vary by location on the screen, and to differ between the left and right eyes.

This differential illumination produces a variation in crosstalk across the screen as well as unequal crosstalks between the two images. Specifically, at a given screen location, the crosstalk from a first-eye image to the second eye is given by the ratio of the illumination of the first-eye image at the given screen location to the illumination of a pixel of the second-eye image at that location. This means that, at a particular pixel, the differential illumination ratio for one eye is the reciprocal of the ratio for the other eye. In general, one may expect that for locations other than the horizontal centerline of the screen (where illumination for both the left- and right-eye images is substantially equal in a well-adjusted projector), the crosstalk will be different for each eye.

For projection systems whose leakage is substantially uniform and symmetrical (e.g., the particular filters, screen, and other optics chosen have a substantially constant leakage from one eye to the other), differential illumination will cause differential crosstalk from eye-to-eye of one image that may vary across the screen. For such projection systems, the crosstalk at any given point on the screen is the product of the differential illumination ratio at that point (which is spatially varying) and the constant leakage. This was shown in the above numerical example, where the uniform leakage of 10% with a differential illumination of 2:1 in a region produced a crosstalk of 20% for one eye, and 5% for the other.

This differential crosstalk is not compensated for by any of the prior teachings, and will arise from any of the combinations of differential distortions (regardless of whether differential distortions are corrected or not), differential illumination (when incompletely corrected), and other sources of crosstalk.

The present invention provides a method to characterize the crosstalk and differential illumination for a projection system, and to at least partially compensate for crosstalk (i.e., reduce the visible effects of crosstalk) in the presence of differential illumination, Compensation can also be provided in a film or digital image data or file to at least partially mitigate the effect of differential keystoning.

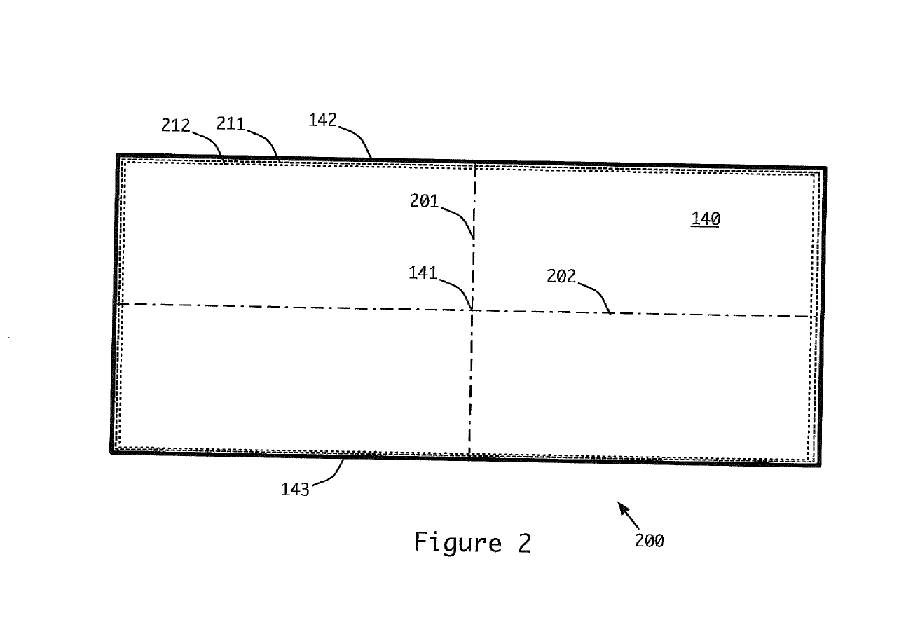

FIG. 2 shows a projected presentation 200 of a stereoscopic image pair on the viewing portion of projection screen 140 with a center point 141. Projected presentation 200 has a vertical centerline 201 and a horizontal centerline 202 that intersect each other substantially at the center point 141.

When properly aligned, the left- and right-eye projected images are horizontally centered about vertical centerline 201 and vertically centered about horizontal centerline 202, with perimeter defined by ABCD. The tops of the projected left- and right-eye images are close to the top 142 of the visible screen area, and the bottoms of the projected images are close to the bottom 143 of the visible screen area

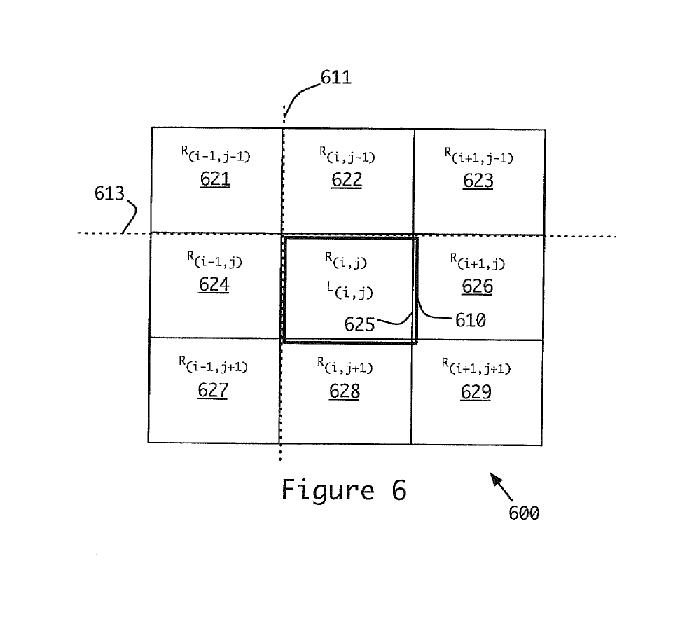

In one embodiment, where there is little differential distortion between the projected left- and right-eye images, or if sufficient differential distortion correction has been made, then the boundaries of the projected left- and right-eye images 112 and 111 are represented by left-eye projected image boundary 212 and right-eye projected image boundary 211, respectively, with boundaries 211 and 212 being substantially equal (e.g., overlapping each other). Other embodiments having substantial uncorrected differential distortion, not shown, are discussed in conjunction with FIG. 6.

Because of the nature of lens 130, images 111 and 112 on the film 110 become inverted when projected onto screen 140. Thus, the film 110 is provided in the projector with the images inverted such that the projected images would appear upright. As shown in FIG. 1, the top 111T of right-eye image 111 and the bottom 112B of left-eye image 112 are located close to the center of the opening in aperture plate 120, while the bottom 111B of right-eye image 111 and the top 112T of left-eye image 112 are located near the edges of the aperture plate opening. When projected, the tops 111T and 112T of the respective images will appear near the top edge 142 of the screen 140, and the bottoms 111B and 112B of the images will appear near the bottom edge 143 of the screen 140.

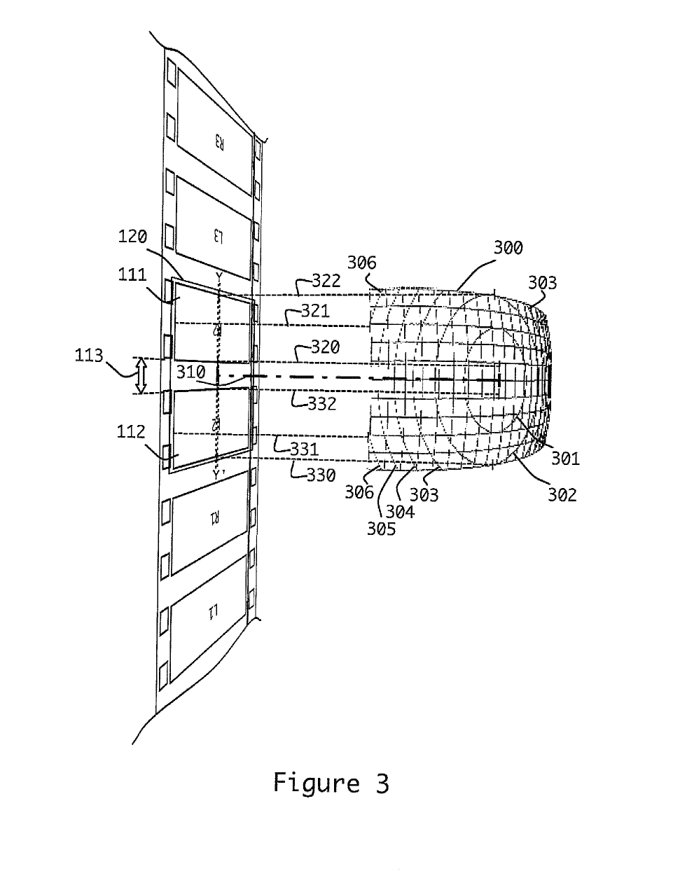

The illumination provided by the light source and condenser optics (not shown) is often not uniform across the opening in aperture plate 120. Typically, for a well-aligned light source and projection system 100, the center of the opening in aperture plate 120 is the brightest, and the illumination falls off in a more or less radial pattern, as shown by example in FIG. 3, which shows an illumination profile 300 (or illuminant flux) across the opening in aperture plate 120. The radially symmetric brightness distribution profile is illustrated by contour lines 301-306, which represent lines of constant brightness. For some light sources, these contour lines 301-306 would form ellipses or other smooth shapes, rather than circles as shown in FIG. 3. The maximum illumination 310 corresponds to the center of the opening in aperture plate 120, which also lies on the vertical centerline YY′ of images 111 and 112 and in the middle of intra-frame gap 113. Thus, typically, in a stereoscopic over-and-under configuration as shown, the illuminator's brightest region, the very center, is not used to project any portion of an image onto screen.

In one example, contour line 301 identifies brightness values that are 95% of the maximum brightness value 310 at the center of the aperture opening. Brightness values 320 and 332 along the centerline YY′ and corresponding to the top of right-eye image 111 and bottom of left-eye image 112, respectively, are both close to the maximum brightness 310, and in this example, are approximately equal to each other. In addition, contour lines 302, 303, 304, 305 and 306 represent respective brightness values of 90%, 85%, 80%, 75%, and 70% of maximum brightness 310.

From brightness profile 300, one can determine that the brightness value 330 at the top 112T of left-eye image 112 is approximately 90% that of central brightness value 310 (from its proximity to contour line 302), and approximately equal to brightness value 322 at the bottom 111B of right-eye image 111.

As a further illustration, brightness value 331 corresponds to a location along a side edge of left-eye image 112 and would be about 70% of central brightness value 310, as read from its proximity to contour line 306. Likewise, brightness value 321 corresponding to a location along the side edge of right-eye image 111 is also about 70% of central brightness value 310.

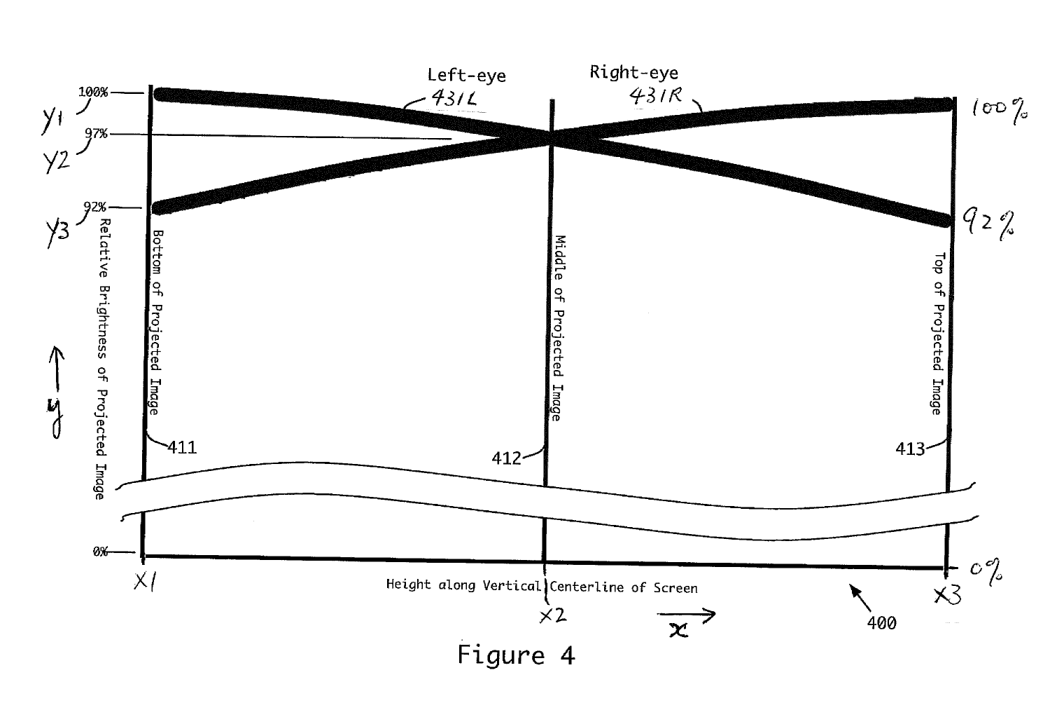

When the projection light source having illumination profile 300 is used for projecting stereoscopic images through the dual-lens system 130, it results in a brightness distribution at the screen, which can be represented by brightness profiles such as those shown in FIG. 4. Graph 400 shows the relative brightness profiles 431R and 431L, which plot, on the y-axis, relative brightness for the projected right- and left-eye images respectively, along the vertical centerline 201 on the screen (see FIG. 2) as a function of the height above the bottom edge 143 (along the x-axis). When referring to the relative brightness of images, the comparison is most clearly discussed among film images of uniform density, although, in practice, this is not a requirement. Alternatively, since the comparisons are relative, the projector may be considered to be operating “open gate”, that is, with no film in the projector. What is not intended here is to consider variations in image density or the resultant screen brightness due to photographic impressions represented on the film 110 or stereoscopic disparities between images 111 and 112. That is, the brightness variations discussed in connection with FIG. 4 are strictly due to the variation in illumination profile as discussed with respect to FIG. 3.

In FIG. 4, the x-axis starts from a minimum height coordinate x1 corresponding to the bottom edge 143 of the visible portion of projection screen 140, increases to an intermediate height coordinate x2 corresponding to the horizontal centerline 202, and to a maximum height coordinate x3 corresponding to the top edge 142 of the screen.

On the y-axis, the maximum relative brightness value y1 of 100% corresponds to the brightest portion of the projected images. In this example, the brightness profiles 431L and 431R show that the brightest portions correspond respectively to the bottom 112B of projected left-eye image 112 (brightness level 332 in FIG. 3), and the top 111T of projected right-eye image 111 (brightness level 320 in FIG. 3).

In this example, brightness curves 431L and 431R are symmetrical with respect to each other about the height x2. In an alternative embodiment, the curves may be asymmetrical due to the pattern of illumination through the opening of aperture plate 120, the geometry of projection system 100, the nature of screen 140, or the seating positions of the audience (the last two factors being relevant only for brightness profiles derived from luminance measurements). For the purpose of clarity, however, this discussion relates to a system having symmetric falloff of the illumination with respect to the horizontal center line of the screen, i.e., height x2 in graph 400.

Along the vertical centerline 201, the minimum brightness is about 92% at coordinate y3 for the bottom of projected right-eye image (height coordinate x1) and the top of projected left-eye image (height coordinate x3). The projected right- and left-eye images have equal brightness (about 97%) only around coordinate x2, i.e., near the horizontal centerline 202.

As evident in FIG. 4, for any height coordinate x smaller than x2 (i.e., below the horizontal centerline 202), the projected left-eye image is brighter than the projected right-eye image, while for any x larger than x2 (i.e., above the horizontal centerline 202), the projected right-eye image is brighter than the projected left-eye image.

The stereoscopic brightness disparity that occurs where the brightness curves 431L and 431R diverge from each other can be reduced or eliminated by adding extra density to a film print in the regions of images where the brightness curve for one stereoscopic image exceeds that of the image for the other eye, as taught in US published patent application, US 2011/0007132 A1. However, if such extra density is not added, or if the added density does not completely eliminate the differential brightness, then the remaining differential brightness will affect the amount of crosstalk from each eye's image to the other.

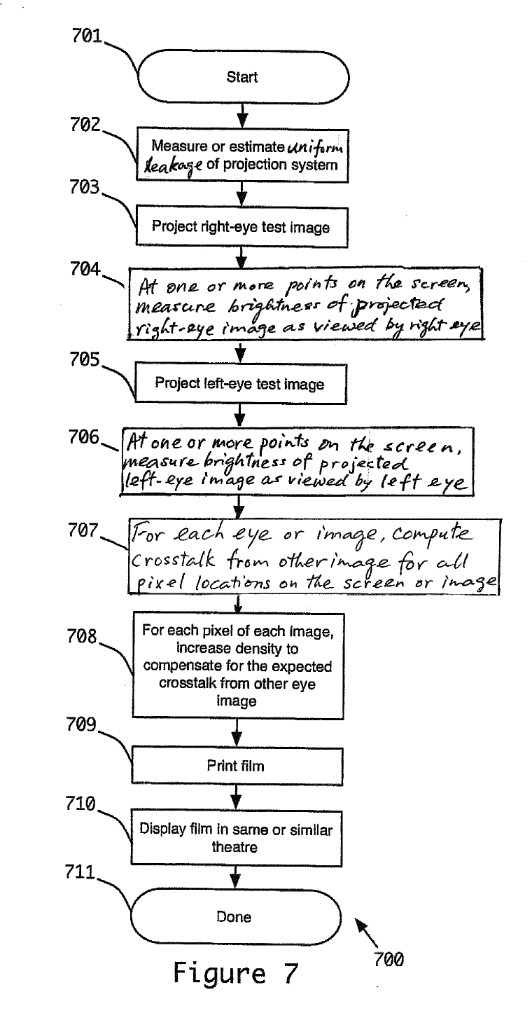

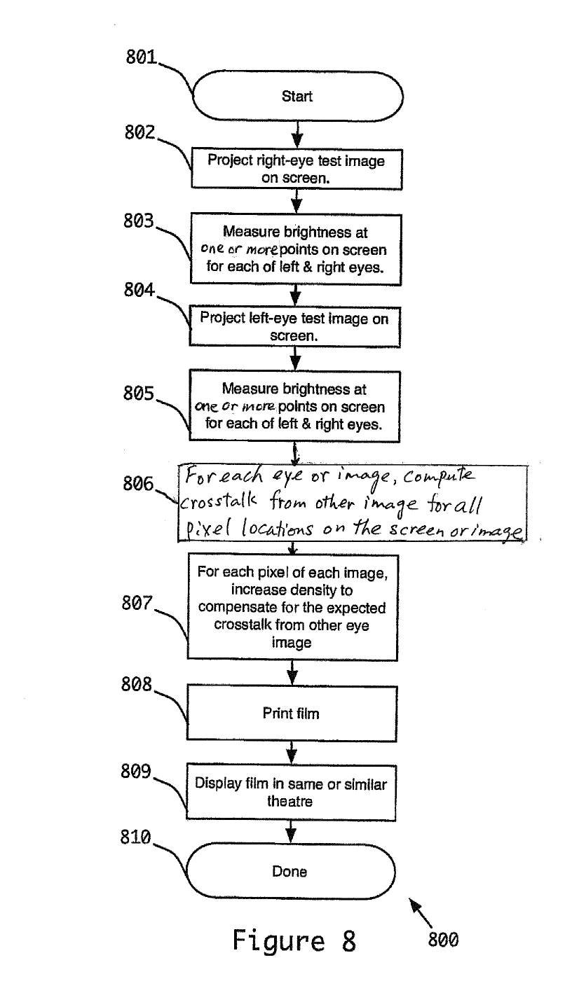

The amount of crosstalk at a point, including the effects of differential brightness, may be measured directly (as discussed in conjunction with FIG. 8), or computed from a measurement of differential brightness at a point and a measurement of crosstalk at another point (as discussed in conjunction with FIG. 7). Estimates of crosstalk for a point may be made by interpolating or extrapolating from the crosstalk of other points on the screen. Further, estimates of crosstalk for a point on a screen may be made from measurements of crosstalk from other, similar projection systems.

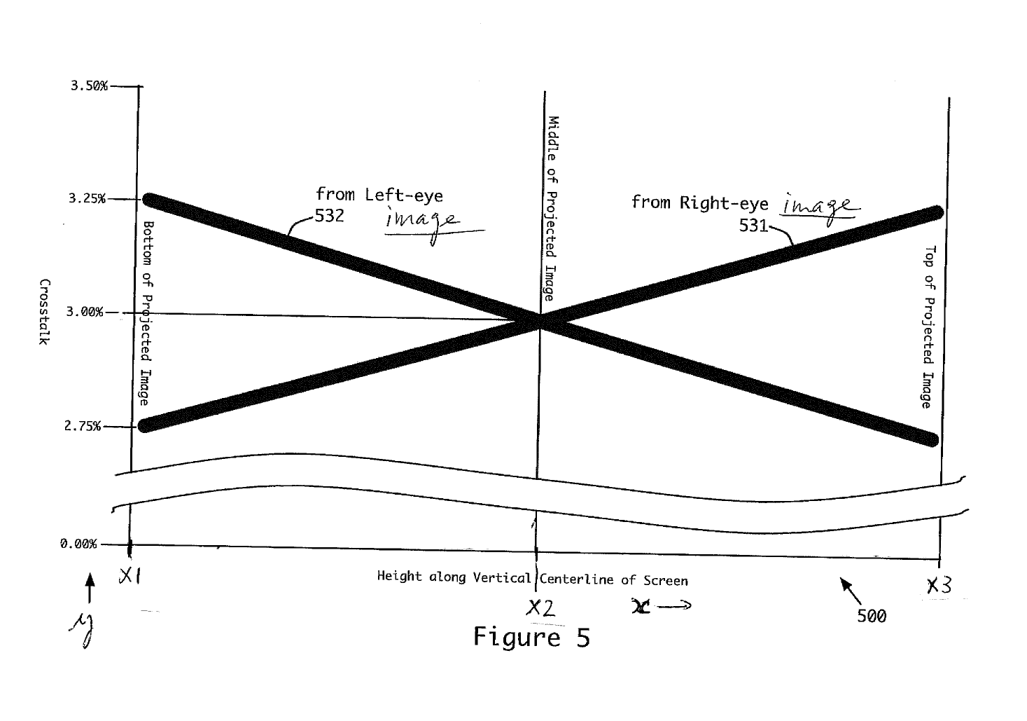

FIG. 5 shows a graph of crosstalk from the projections of the right- and left-eye images 111 and 112, resulting from the differential brightness shown in FIG. 4. The amount of crosstalk is plotted on the y-axis as a function of the height along the vertical centerline 201 on projection screen 140, which is represented by the x-axis. Screen height coordinate x1 represents the bottom edge 143 of screen 140, while screen height coordinate 513 represents the top edge 142 of screen 140. Screen height coordinate x2 represents the height of the horizontal centerline 202 on screen 140.

Here, crosstalk observed by one eye, e.g., right eye, is the ratio of the brightness of a first pixel from a “wrong” image, i.e., from the left-eye stereoscopic image, to the brightness of a second pixel (at about the same screen location as the first pixel) from the right-eye stereoscopic image, i.e., “correct” image. Crosstalk is usually expressed herein as a percentage. In most projection systems without differential brightness issues and screen damage (e.g., a stain on screen 140), the crosstalk is generally uniform across the whole screen, with typical values are about 3-5%.

As shown in FIG. 5, curve 531 represents the crosstalk from the right-eye image seen by the left eye, and curve 532 represents the crosstalk from the left-eye image seen by the right eye. The minimum crosstalk along the vertical centerline 201 is about 2.75%, with crosstalk seen by the left eye originating from the bottom of a projected right-eye image near height coordinate x1, and crosstalk seen by the right eye originating from the top of projected left-eye image near height coordinate x3.

Along the vertical centerline 201 of screen 140 (represented by x-axis of FIG. 5), crosstalks from projected left- and right-eye images are the same only near height coordinate x2 (i.e., horizontal centerline 202 or half way up the screen), and as shown by the intersection of crosstalk curves 532 and 531, has a crosstalk value of 3.00%. That is, with right- and left-eye images 111 and 112 having the same content, at least near their respective centers, the brightness of center point 141 as measured through right-eye filter 171 when only left-eye image 112 is being projected will be 3.00% of the brightness of point 141 as measured through right-eye filter 171 when only right-eye image 111 is being projected. Corresponding measurements made through the left-eye filter 172 will also result in the same crosstalk value from the right-eye image.

Curve 532 shows a similar pair of brightness measurements through right-eye filter 171 at the center of top edge 142 with a crosstalk value of 2.75% from the left-eye image at height coordinate x3.

FIG. 6 illustrates a region 600 of an overlaid stereoscopic image pair around a left-eye image pixel 610 (shown as a rectangle in bold) and surrounding pixels from the right-eye image that may contribute to crosstalk at the pixel 610. (Note that the pixels in FIG. 6 refer to those in the original images, before any distortion correction.) For convenience in this discussion, in FIG. 6, we consider that the particular region of interest 600 exhibits only a small differential distortion, if any, with respect to other-eye pixel 610, when projected (for example, because the region 600 may have been aligned so as to overlay pixels 610 and 625, or perhaps convergence angle 182 is sufficiently small due to throw 181 being sufficiently large with respect to inter-axis distance 180). In general, however, this is not necessarily the case and the offsets to pixel indices ‘i’ and T will vary between eyes and change in different areas of the screen unless sufficient distortion compensation, e.g., as taught in co-pending application, US 2011/0038042 A1, has been applied. Having little residual differential distortion will result in overlaid projected stereoscopic images, and thus, performing the crosstalk correction between the original images is a valid approach, since it is known or expected that the distortion compensation will substantially correct for the differential distortion in the projection (and to the extent that it does not, any additional crosstalk contributions can be addressed based on the uncertainty related to the distortion compensation, as will be discussed below).

Left-eye image pixel 610 has coordinate {i,j}, and is designated L(i,j). Right-eye pixel 625, with coordinate designation R(i,j), is the pixel in the right-eye image that corresponds to the left-eye pixel 610, i.e., the two pixels should overlap each other in the absence of differential distortion. Other pixels in region 600 include right-eye image pixels 621-629 within the neighborhood of, or proximate to, pixel 610. Left-eye pixel 610 is bounded on the left by grid line 611, and at the top by grid line 613. For this example, grid lines 611 and 613 may be considered to have the coordinate values of i and j, respectively, and the upper-left corner of left-eye pixel 610 is thus designated as L(i,j). Note that grid lines 611 and 613 are straight, orthogonal lines and represent the coordinate system in which the left- and right-eye images exist. Although pixels 610 and 625 and lines 611 and 613 are meant to be precisely aligned to each other in this example, they are shown with a slight offset to clearly illustrate the respective pixels and lines.

Right-eye pixels 621-629 have top-left corners designated as {i−1, j−1}, {i, j−1}, {i+1, j−1}, {i−1, j}, {i, j}, {i+1, j}, {i−1, j+1}, {i, j+1}, and {i+1, j+1}, respectively. However, if projected without geometric compensation, the images of left-eye pixel 610 and corresponding right-eye pixel 625 may not be aligned, or even overlap due to the differential geometric distortions. Even with the application of an appropriate image warp to provide the geometric compensation of film 400, there remains an uncertainty, e.g., expressed as a standard deviation, as to how well that warp will produce alignment, either due to uncertainty in the distortion measurements of a single projection system 100, or due to variations among multiple theatres. Specifically, the uncertainty refers to the remainder (or difference) between the actual differential distortion and the differential distortion for which compensation is provided (assuming that the compensation is modeling some measure of the actual distortion) to the film, e.g., film 110, when the compensation is obtained based on a measurement performed in one lens system, or based on an average distortion determined from measurements in different lens systems. Sources of this uncertainty include: 1) imprecision in the measurements, e.g., simple error, or rounding to the nearest pixel; 2) statistical variance when multiple theatres are averaged together, or 3) both.

Due to the uncertainty in the alignment provided by the distortion correction warp, there is an expected non-negligible contribution to the crosstalk value of the projection of left-eye pixel 610 from right-eye pixels 621-629, which are up to 1 pixel away from pixel 610 (this example assumes an uncertainty in the alignment or distortion compensation of up to about 0.33 pixels and a Gaussian distribution for the distortion measurements). However, if the uncertainty exceeds 0.33 pixels, then additional pixels (not shown) that are farther away than pixels 621-629 may also have non-negligible crosstalk contributions.

While right-eye image pixel 625 will have the greatest expected contribution to the crosstalk at the projection of left-eye image pixel 610, neighboring pixels 621-624 and 626-629 may have non-zero expected contributions. Further, depending on the magnitude of the uncertainty for the alignment at any given pixel, additional surrounding right-eye image pixels (not shown) may also have a non-negligible expected contribution.

In one embodiment, when determining the contributions by pixels of the right-eye image to the crosstalk value at the projected left-eye image pixel 610, this uncertainty in the distortion correction of an image is addressed. In one example, a Gaussian blur is used to generate a blurred image, which takes into account the uncertainty in the locations of the pixels in a first eye's image (arising from uncertainty in the distortion measurements or correction) that are expected to contribute to the crosstalk value of a pixel in the other eye's image. Thus, instead of using the actual value of right-eye image pixel 625 in calculating the crosstalk value, the value for pixel 625 is provided by using a blurred or a lowpass filtered version (Gaussian blur is a lowpass filter) of the right-eye image. In this context, the value of the pixel refers to a representation of one or more of a pixel's properties, which can be, for example, brightness or luminance, and perhaps color. The calculation of crosstalk value at a given pixel will be further discussed in a later section.

Note that the converse is also true. When considering the crosstalk contributions from the projection of the left-eye image at the projection of the right-eye image pixel 625, a lowpass filtered version of the left-eye image is used to provide a “blurred” pixel value of pixel 610 for use in crosstalk calculations in lieu of the actual value of pixel 610.

The behavior of the lowpass filter, or the amount of blur, should be proportional to amount of the uncertainty, i.e., greater uncertainty suggesting a greater blur. In one method, for example, as known to one skilled in the art, a Gaussian blur can be applied to an image by building a convolution matrix from values of a Gaussian distribution, and applying the matrix to the image. In this example, the coefficients for the matrix would be determined by the magnitude of the uncertainty expressed as the standard deviation a (sigma) of the residual error after the geometric distortion compensation has been imposed, in accordance with the following formula:

$${G}_{circular} ( x , y ) = \frac{1}{2 {πσ}^{2}} {e}^{- \frac{{x}^{2} + {y}^{2}}{2 {σ}^{2}}} \qquad EQ . 1$$

In this equation, the coordinates {x,y} represent the offsets in the convolution matrix being computed, and should be symmetrically extended in each axis in both the plus and minus directions about zero by at least 3σ (three times the magnitude of the uncertainty) to obtain an appropriate matrix. Once the convolution matrix is built and normalized (the sum of the coefficients should be unity), a lowpass-filtered value is determined for any of the other-eye image pixels by applying the convolution matrix such that the filtered value is a weighted average of that other-eye image pixel's neighborhood, with that other-eye image pixel contributing the heaviest weight (since the center value in the convolution matrix, corresponding to {x,y}={0,0} in EQ. 1, will always be the largest). As explained below, this lowpass-filtered value for the pixel can be used for calculating a crosstalk contribution from that pixel. If the values of other-eye image pixels represent logarithmic values, they must first be converted into a linear representation before this operation is performed. Once a lowpass-filtered value is determined for an other-eye pixel, the value is available for use in the computation of the crosstalk value in one or more of the methods described below, and is used in lieu of the other-eye's pixel value in crosstalk computation.

In one embodiment, the uncertainty may be determined at various points throughout screen 140, such that the standard deviation, e.g., σ(i,j), is known as a function of the image coordinate system. For instance, if the residual geometric distortion is measured at or estimated for the center and each corner over many screens, σ can be calculated separately for the center and each corner and then σ(i,j) represented as an interpolation among these.

In another embodiment, the expected deviation of the residual geometric distortions may be recorded separately in the horizontal and vertical directions, such that the uncertainty σ(i,j) is a vector with distinct horizontal and vertical uncertainties, σₕ and σᵥ which can be used to model an elliptical uncertainty, by calculating the coefficients of the convolution matrix as in EQ. 2.

$${G}_{elliptical} ( x , y ) = \frac{1}{2 {πσ}_{h} {σ}_{v}} {e}^{- [ \frac{{x}^{2}}{2 {σ}_{h}^{2}} + \frac{{y}^{2}}{2 {σ}_{v}^{2}} ]} \qquad EQ . 2$$

In still another embodiment, the elliptical nature may further include an angular value by which the elliptical uncertainty is rotated, for example if the uncertainty in the residual geometric distortions were found to be radially oriented.

In order to determine suitable compensation for crosstalk at any given point in the projected images, the amount of crosstalk should be determined or estimated. Details of how the crosstalk and leakage terms can be derived from measurements are further discussed below.

As previously discussed, leakage can be expressed as a fraction of the projected light from a first image that passes through the viewing filter for the second stereoscopic image, and thus, viewed by the “wrong” eye (the projected first image is intended for viewing only by the first eye) relative to that passing through the viewing filter for the first stereoscopic image. For example, for light projected through right-eye image filter 151, leakage is given by the amount of light passing through left-eye filter 172 divided by the amount passing through right-eye filter 171, and for many systems is uniform across screen 140.

Crosstalk is the amount of light projected through right-eye image filter 151 that passes through left-eye filter 172 divided by light projected through left-eye image filter 152 that passes through left-eye filter 172. In both cases, the calculation or measurement would consider only light reflected off the same region of the screen if the leakage in the system is not spatially uniform.

Thus, leakage that is homogeneous (e.g., spatially uniform), and denoted by the term leak_{U} (i.e., ‘uniform leakage’) can be determined anywhere on screen 140 based on four luminance measurements, which are obtained by consecutively projecting each of right- and left-eye images 111 and 112 and, for each projected image, measuring the amount of light reflected from a region of screen 140 as seen through each of filters 171 and 172 from the same location in the theatre. This operation presumes that the theatre is otherwise dark and that the only substantial source of light is the projected image, and that the region on the screen is for which measurement is performed is completely illuminated. Note that for these measurements, the projected image may be open-gate (applies only to film, not digital projection), or white, or it may be a more complex image, as long as there is no stereoscopic disparity between the left and right images (i.e., same content at a point on the screen for left and right eye).

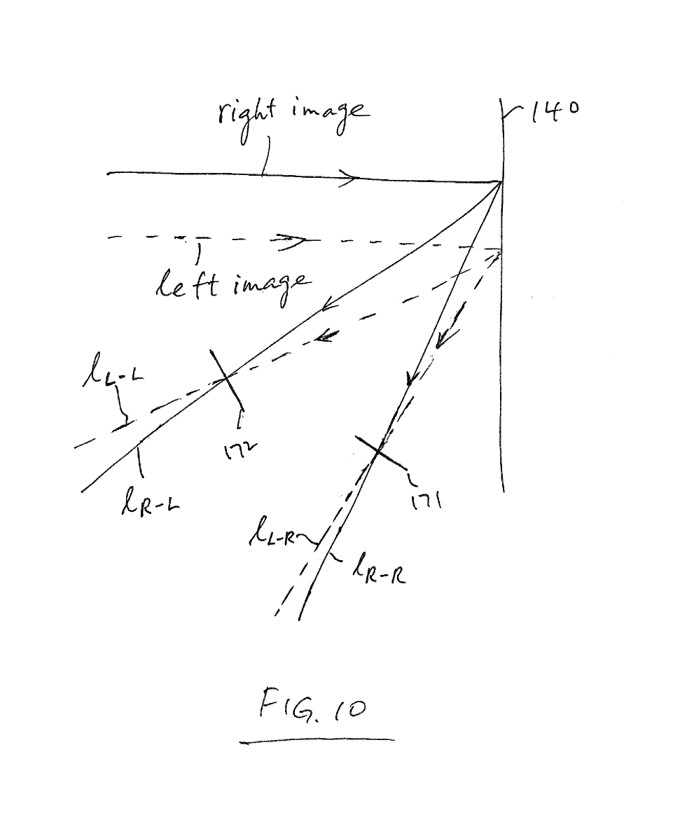

Leakages from one eye to the other eye are given by the following ratios of respective luminance values:

$$\begin{matrix}{leak}_{R -> L} ( i , j ) = \frac{{l}_{R - L} ( i , j )}{{l}_{R - R} ( i , j )} & EQ . 3 A \\ {leak}_{L -> R} ( i , j ) = \frac{{l}_{L - R} ( i , j )}{{l}_{L - L} ( i , j )} & EQ . 3 B\end{matrix}$$

where leak_{R→L} is the leakage from the right-eye image into the left eye (e.g., through left-eye viewing filter 172) with respect to the same image as viewed by the right eye (e.g., through right-eye viewing filter 171); leak_{L→R} is the leakage from the left-eye image into the right eye with respect to the same image as viewed by the left eye; refers generally to the luminance of the projected image for eye A as viewed through the filter for eye B, with subscript L representing the left eye or image, and subscript R representing the right eye or image, and (i, j) are coordinates for a pixel in the image or a location on the screen corresponding to that image pixel. These luminance parameters are illustrated in FIG. 10.

In many stereoscopic projection systems, leakage may be considered to be constant or uniform for all locations or pixels (i, j) on the screen. That is, measurements and audience members 160 would not notice any meaningful variations in leakage at different parts of the screen or image.

It is also generally the case that leakage is symmetrical and that leak_{L→R} is equal to leak_{R→L}. That is, if leak_{R→L} is obtained by projecting right-eye image 111 through filter 151 and measuring l_{R-L} through filter 172 and l_{R-R} through filter 171, substantially the same result will be obtained for leak_{L→R} by projecting left-eye image 112 through filter 152 and measuring l_{L-R} through filter 171 and l_{L-L} through filter 172 (though rare exceptions to this symmetry can be constructed, for example, if shutters are used on the lens and/or glasses and the timings and/or biases of the shutters are poorly selected or set).

Thus, for most practical systems, leak_{L→R} (i, j) and leak_{R→L}(i, j) are both constant across screen 140 (i.e., uniform, with little or no spatial variation) and equal for both eyes (i.e., symmetrical leakage). In such a case where leakage to the wrong eye is, for all practical purposes, constant from an audience member's viewpoint, it can also be represented by “leak_{US}” to mean both uniform and symmetrical leakage where leak_{R→L}=leak_{L→R}, in which case:

$${leak}_{US} = \frac{{l}_{R - L} ( i , j )}{{l}_{R - R} ( i , j )} = \frac{{l}_{L - R} ( i , j )}{{l}_{L - L} ( i , j )} \\ for all \{ i , j \} \qquad EQ . 4$$

Crosstalk, as defined herein, can be determined from the same measured luminance values, as follows:

$$\begin{matrix}{crosstalk}_{R -> L} ( i , j ) = \frac{{l}_{R - L} ( i , j )}{{l}_{L - L} ( i , j )} & EQ . 5 A \\ {crosstalk}_{L -> R} ( i , j ) = \frac{{l}_{L - R} ( i , j )}{{l}_{R - R} ( i , j )} & EQ . 5 B\end{matrix}$$

where crosstalk_{R→L} is the crosstalk from the right-eye image into the left eye; l_{R-L}, l_{L-L}, l_{L-R}, l_{R-R} are the respective luminances measured by projecting the corresponding right- or left-eye image and viewing through the appropriate eye's filter as described above; and i and j are coordinates used to describe a location in the image or a corresponding location on the screen (e.g., the coordinates as described in conjunction with FIG. 6) with respect to which luminance measurements are made. The crosstalk from the left-eye image into the right eye is given by EQ. 5B, with corresponding terms defined similarly as described above.

However, the properties of uniformity and symmetry that apply to uniform leakage do not extend to the crosstalk when there is differential illumination of the right- and left-eye images 111 and 112 (i.e., crosstalk is not generally uniform and symmetric), except at points on the screen 140 where the illuminations for both images are equal. This can be illustrated by rewriting EQ. 5A-B and rearranging the various luminance terms as shown below:

$$\begin{matrix}\begin{matrix}{crosstalk}_{R -> L} ( i , j ) = [ \frac{{l}_{R - L} ( i , j )}{{l}_{L - L} ( i , j )} ] [ \frac{{l}_{R - R} ( i , j )}{{l}_{R - R} ( i , j )} ] \\ = [ \frac{{l}_{R - R} ( i , j )}{{l}_{L - L} ( i , j )} ] [ \frac{{l}_{R - L} ( i , j )}{{l}_{R - R} ( i , j )} ]\end{matrix} & EQ . 5 {A}^{′} \\ \begin{matrix}{crosstalk}_{R -> L} ( i , j ) = [ \frac{{l}_{L - R} ( i , j )}{{l}_{R - R} ( i , j )} ] [ \frac{{l}_{L - L} ( i , j )}{{l}_{L - L} ( i , j )} ] \\ = [ \frac{{l}_{L - L} ( i , j )}{{l}_{R - R} ( i , j )} ] [ \frac{{l}_{L - R} ( i , j )}{{l}_{L - L} ( i , j )} ]\end{matrix} & EQ . 5 {B}^{′}\end{matrix}$$

Note that the two luminance terms, l_{R-R} and l_{L-L}, also correspond to the brightness of the respective right- and left images as viewed through the correct eye (or through the corresponding viewing filter), so the crosstalks can be rewritten as a product of the relative brightness for the two images, and leakage (see EQ. 3A-B):

$$\begin{matrix}{crosstalk}_{R -> L} ( i , j ) = \frac{{b}_{R} ( i , j )}{{b}_{L} ( i , j )} \times {leak}_{R -> L} ( i , j ) & EQ . 6 A \\ {crosstalk}_{L -> R} ( i , j ) = \frac{{b}_{L} ( i , j )}{{b}_{R} ( i , j )} \times {leak}_{L -> R} ( i , j ) & EQ . 6 B\end{matrix}$$

In the relative brightness term b_{R}(i, j)/b_{L}(i, j), b_{R}(i, j) represents the brightness for the pixel at screen location {i, j} for the image corresponding to the eye under consideration, i.e., right eye in this example, and b_{L}(i, j) represents the brightness for the pixel at substantially the same location {i,j} for the other-eye image, e.g., left eye (assume negligible differential distortion).

Note that b_{R} and b_{L} may be measured as illuminance or luminance or may be a fraction of some reference brightness, for example, a peak brightness, as in FIG. 4, since in each case, the ratio of the two measurements would produce the same result. For example, illuminance can be measured in lumens by a light meter placed at screen 140 viewing towards the projecting lens, or luminance can be measured in foot-lamberts with a light meter at a location at or near audience member 160 viewing at screen 140. These measurements may be made with or without the corresponding viewing filter 171, 172 for the projected image 111, 112, e.g., by covering or blocking the right eye image when measuring brightness for the left image, and vice versa. (In fact, if selecting luminance as the brightness measure of b_{L} and b_{R}, the measurements of l_{L-L} and l_{R-R} may be used for b_{L} and b_{R}, respectively.)

Such brightness measurements can be made with the pertinent image projected while the other is black or blocked, or the measurement can be made through the corresponding viewing filter 172 or 171 (respectively) to attenuate most contribution from the other eye image.

From EQ. 6A-B, it is clear that the crosstalks at most locations {i, j} are different for the left and right eyes (i.e., not symmetrical), since the ratio of b_{R} to b_{L} is not equal to its reciprocal except where b_{R}=b_{L}, (which, in a well-adjusted version of the current embodiment, is generally along horizontal centerline 202 of the image, e.g., where curves 431L and 431R intersect, as shown in FIG. 4).

The advantage of determining leak_{US} in a system having uniform and symmetric leakage, is that the crosstalk for both eyes, crosstalk_{R→L}(i,j) and crosstalk_{L→R}(i,j), can be obtained with only two measurements (i.e., of b_{L} and b_{R}) at the designated location {i,j} on the screen, in accordance with EQ. 6A-B, since leak_{L→R} (i, j)=leak_{R→L} (i, j)=leak_{US}. Otherwise, using EQ. 5A-B, four measurements must be taken at each location of interest on the screen.

Generally, crosstalk varies smoothly over the screen, so an array of several widely-spaced points, for example, a 5×5 grid, can provide adequate characterization for interpolation or extrapolation for crosstalk values at other locations where measurements are not performed. Furthermore, in EQ. 6, either or both of the brightnesses b_{L} and b_{R} may be estimated by interpolation or extrapolation, so it is not strictly required that the brightness or luminance measurement locations for each eye's image be the same. This is further discussed in conjunction with FIG. 7.

The crosstalk defined above (i.e., in EQ.5 and EQ.6) based on the leakage terms represent the crosstalk associated with the projection system or its components, or system-related crosstalk. However, the actual crosstalk from one eye's image in a film to the other eye also depends on the content of the image of the film.

Thus, if t_{R}(i,j) and t_{L}(i,j) represent the transmissivity of a particular pixel in a particular instance of the respective right-eye image and left-eye image, which are expected to change frame by frame as the film is presented, then the net crosstalk of light from the right eye image into the left eye is shown in EQ. 7A, and the net crosstalk from the left eye image to the right eye is shown in EQ. 7B.

$$\begin{matrix}\begin{matrix}net\_ {crosstalk}_{R -> L} ( i , j ) = {t}_{R} ( i , j ) \times {crosstalk}_{R -> L} ( i , j ) \\ = {t}_{R} ( i , j ) \times \frac{{b}_{R} ( i , j )}{{b}_{L} ( i , j )} \times {leak}_{US}\end{matrix} & EQ . 7 A \\ \begin{matrix}net\_ {crosstalk}_{L -> R} ( i , j ) = {t}_{L} ( i , j ) \times {crosstalk}_{L -> R} ( i , j ) \\ = {t}_{L} ( i , j ) \times \frac{{b}_{L} ( i , j )}{{b}_{R} ( i , j )} \times {leak}_{US}\end{matrix} & EQ . 7 B\end{matrix}$$

Thus, the actual or net crosstalk for a given pixel is given by the crosstalk associated with the projection system multiplied (or modified) by the corresponding pixel transmissivity for an image in the film. As illustrated below, the net crosstalk value (or expected crosstalk) is used in a method of crosstalk compensation in films or digital image data, e.g., in conjunction with FIG. 7, step 708 and FIG. 8, step 807.

FIG. 7 illustrates a process 700 in which a crosstalk-compensated film or digital image file is produced based on characterization of a dual-lens projection system similar to that in FIG. 1 by measuring a uniform leakage for the system and the brightness of projection at various points on the screen for each eye.

### Step 701

In start step 701, various tasks are performed to prepare a system for crosstalk determination and compensation, e.g., the projection system 100 is lit, allowed to warm up, focused, aligned, and balanced so that the center of the screen receives substantially the same amount of light from each of exit lens elements 135 and 137.

### Step 702

In step 702, the value of uniform leakage (‘l_{R-L}/l_{R-R}’ and ‘l_{L-R}/l_{L-L}’, per EQ. 3A-3B), which may be symmetric (‘leak_{US}’ per EQ. 4), is determined based on the screen brightness for each eye for each of one or two test images, for example, from component or system specifications, by estimation, or by measurements (described below). Crosstalk can be determined based on different leakage measurements, depending on whether EQ. 3A-B (the system leakage is uniform, but can be either symmetric or asymmetric) or EQ. 4 (the system leakage is uniform and assumed or known to be symmetric) is used. EQ. 4 can be used to obtain the value of “leak_{US}”, by taking either pair of measurements from any one point on the screen, since leak_{US} is substantially equal to leak_{L→R}(i,j) or leak_{R→L}(i,j), in systems where the leakage is symmetrical. Different test image arrangements can be used for measuring various luminance terms corresponding to each test image for the corresponding eye. For example, a first test image (for one eye) may be projected open gate, with the other eye's lens blocked; or a white image can be used for the first test image with a black image for the other eye's lens; or the first test image can contain a number of illuminated regions as measurement locations; or a series of illuminated regions can be projected one at a time (as part of the first test image) for measurements.

While there are only minor restrictions on the test image(s) for crosstalk compensation process 700, e.g., that the measurement point(s) not be black, there are several practical concerns. First, if the image contains one or more patterns with high spatial frequencies (e.g., a dense checkerboard or stripes), then a slight variation in the measurement target (e.g., due to sensor movement or film jitter and weave) can produce differences between one measurement and the next, which can add significant noise to the measurements and calculated results. Second, although projection system can be run open gate (i.e., without film) or run with clear leader (i.e., film having a minimum possible density) for the measurements, long exposure to such high energy flux may overheat one or more elements of lens system 130 or filters 151 and 152, thus causing damage. Third, if the image is too dense, the luminance measurements become difficult to make because of low signal levels, thus requiring more sensitive, low-noise meters, which tend to be uncommon, slow, and expensive.

Thus, an ideal test image (for either eye) preferably has few, if any, patterns with high spatial frequencies, low density portions, and/or high density portions. Low density portions and high density portions, if present, preferably have relatively small areas. For example, a 50% grey field in one eye and maximum density (black) in the other eye makes an ideal pair of test patterns, though other uniform densities can be selected and minor embellishments (e.g., labeling for the right and left images, fiducial markings, focus targets, etc.) may also be included, as long as the density is not too high so as to make luminance measurement difficult. A number of these test image pairs can be provided as alternate left- and right-eye images in a continuous film loop for testing purpose.

Thus, in a projection system with uniform leakage, the values of leak_{R→L} and leak_{L→R} may be determined by making four luminance measurements at an arbitrary location on the screen, two each of images for each eye; or in cases where the uniform leakage is also symmetric, leak_{US} may be determined by making two luminance measurements of the single eye's image at a location on the screen to obtain either leak_{R→L} or leak_{L→R} for use as leak_{US}.

### Steps 703-704

In step 703, a first test image is projected, e.g., projecting the right eye image or running the projection system open gate, with the left-eye image being dark or blocked.

In step 704, the brightness of the projected image as viewed by the first eye (e.g., right eye) is measured at one or more points across screen 140. The brightness can be measured as luminance or illuminance (or other brightness-related parameter), with or without the projection and/or viewing filter. Thus, the measured brightness may correspond to the l_{R-R} term. In one example, the screen is divided into a number of zones, e.g., a 5×5 grid, with measurement points evenly spaced throughout the screen, such as at the center of each region. Alternatively, a different number of measurement points can be used (preferably, at least two), and the spacing may be uneven, for example with more points being measured in regions where the rate at which brightness changes (i.e., db_{R}/di or db_{R}/dj) is higher.

### Steps 705-706

In step 705, a test image for the other eye is projected, e.g., projecting the left-eye image or running the system open gate, with the right-eye image 111 being black, or blocked. This is followed by measurement step 706 in which the brightness of the projected image as viewed by the left eye at one or more points across screen 140 is measured in a manner similar to that described for step 704. In other words, the procedures in steps 703-704 are repeated for the left-eye image as viewed by the left eye, and the corresponding brightness parameter (e.g., illuminance or luminance) is measured using the filter configuration (i.e., with or without projection and/or viewing filter) as in step 704. Thus, if the brightness term measured in step 704 is l_{R-R}, the brightness term in step 706 should be l_{L-L}.

In systems where the brightness varies smoothly throughout, then measurement locations for the left-eye image do not need to be the same locations as measured for the right-eye image in step 704, since interpolations and/or extrapolations of brightness into areas not directly measured will be accurate. In particular, if the spacing of the measurement locations is uneven, then more points can be measured in regions where the rate at which brightness changes (e.g., db_{L}/di or db_{L}/dj) is higher. Otherwise, if the images do not have smoothly varying brightness, the measurements must be made at substantially the same locations for both stereoscopic images.

### Step 707

In crosstalk computation step 707, the crosstalk_{R→L}(i,j) and crosstalk_{L→R}(i,j) are first computed at each measurement point based on the values of leak_{US} and brightness values measured in steps 702, 704 and 706, e.g., using EQ. 6A-B and the presumption of uniform leakage, whether leak_{R→L}, leak_{L→R}, or leak_{US}. If the right- and left-eye measurements taken in steps 704 and 706 do not have common locations, then the values for b_{R} and b_{L} should be determined for a given set of measurement locations for both images, e.g., by interpolation or extrapolation from the appropriate set of measurements.

The crosstalks expected at all other pixel locations (i.e., other than those obtained for the above measurement locations) of each stereoscopic image are then determined based on the crosstalk values obtained above for the measurement locations by interpolation or extrapolation, as appropriate. The interpolation and extrapolation may include fitting an equation to the measured data and calculating values for intermediate pixels that were not measured from the equation. Once computed, the complete set of values of crosstalk_{R→L} and crosstalk_{L→R} for all the pixels of the left- and right-eye images may be stored for use with each stereoscopic image pair.

Alternatively, other approaches can also be used, instead of computing the complete set of crosstalk values. For example, one approach involves fitting the crosstalk_{R→L} or crosstalk_{L→R} value obtained from the brightness measurement to a simple equation that uses R or L, i, and j as parameters. Another approach involves computing crosstalk values for a denser, regular grid of points (i.e., for a larger number of locations of the screen beyond the measurement locations) to subsequently provide a simpler interpolation (e.g., using a linear relationship, instead of cubic or quadratic) at each pixel. Thus, crosstalk values for only a given number of locations or pixels can be determined in step 707 and stored for subsequent determination of crosstalk values for all pixels required for crosstalk compensation.

### Step 708

In step 708, a crosstalk compensation for each pixel is applied to a film or digital image file to offset the expected net crosstalk, i.e., the crosstalk from a first eye's image in the film or digital file that would be seen by the second (wrong) eye. Specifically, EQ. 7A-B, which multiplies the crosstalk value at a screen location by the transmissivity of a particular pixel at that location, is used to calculate the net crosstalk expected for each pixel of the respective stereoscopic images for the entire film or digital image file. This net crosstalk calculation may include a blurring of the other-eye image (or blurring of t_{R/L}(i,j), a pixel's transmissivity), for example, as discussed in conjunction with FIG. 6, but applying EQ. 1 or EQ. 2 to blur the other-eye image to accommodate the imprecision or uncertainty of alignment between the two projected images. Since crosstalk from a first image of a stereoscopic pair would increase the brightness to the second image, the crosstalk compensation applied here entails increasing the density of the second image in film (on a pixel-wise basis), or reducing the value of the pixel data, such that less light would project through the compensated film print or projected digital image, ideally corresponding to the net crosstalk, and thus, at least partially, offsetting the crosstalk.

In general, there is a minimum amount of compensation, which, when applied, would always reduce the residual crosstalk, and thus, is always preferable to apply some crosstalk compensation compared to no compensation at all. Further, there is also a maximum amount of compensation, which, if exceeded, would produce an appearance of crosstalk that is worse than without any compensation. Thus, there is a range within which the amount of compensation can vary and still produce an improved presentation. Since this range of compensation depends on the specific system, it has to be determined or estimated for each system accordingly. The resulting crosstalk-compensated film negative or digital image file can be used for making film prints for distribution or projection.

### Steps 709-710

One or more films can be duplicated in printing step 709, and when projected in display step 710, would result in presentations with reduced crosstalk. Similarly, a stereoscopic digital image file that incorporates crosstalk compensation as described above will also result in a digital presentation with reduced crosstalk.

In display step 710, if the theatre in which the crosstalk-compensated film print is projected is the same theatre or similar to the theatre or system in which the luminance measurements were made for crosstalk compensation, then the projected film will have little or no crosstalk. However, if the projection system used for presentation differs substantially from the one in which measurements were taken, then some residual crosstalk may remain.

Process 700 concludes at step 711.

FIG. 8 shows an alternative process 800, in which a crosstalk-compensated film or digital image file is produced based on crosstalk characterization of a projection system by measuring brightness terms shown in EQ. 5A-B. Process 800 begins at step 801, which is the same as step 701, in which various tasks are performed to prepare a system for subsequent measurements. However, unlike process 700, the uniform leakage is not presumed in process 800, which means that a larger number of brightness measurements are generally required for determining crosstalks at different locations of the screen.

### Steps 802-803

In step 802, a first test image is projected, e.g., image 111 for the right eye is projected through filter 151 of FIG. 1, or running the projection system open-gate, with the left-eye image being dark or blocked.

In step 803, the brightness of the projected image at a number of points across screen 140 is measured separately for each of the right and left eyes, e.g., through corresponding viewing filters 171 and 172. Measurement can be done at locations evenly spaced throughout the screen, and in one example, in a 5×5 grid. Alternatively, measurements can also be made at other locations, which may or may not be evenly spaced across the screen.

For example, with the projected right-eye image, the two brightness measurements at location (i,j) through the left- and right-eye filters 172, 171 would correspond to the respective terms l_{R-L}(i, j) and l_{R-R}(i, j) to be used in EQ. 5A-B.

### Steps 804-805.

In step 804, the second image, e.g., left-eye test image (which may correspond to running open gate), is projected, with the right eye image being dark or blocked. The constraints on the test images and the implication for number, distribution, and commonality of measurement points are the same as in process 700. In measurement step 805, the luminance for each eye is again measured through corresponding viewing filters 171 and 172. With the projected left-eye image, the two brightness measurements at location (i, j), again through the right- and left-eye filters 171, 172, would correspond to the respective terms l_{L-R}(i, j) and l_{L-L}(i, j) for use in EQ. 5A-B. While it is more convenient for the measurements of steps 803 and 805 to be taken from the same set of locations, this is not a strict requirement, as discussed in the next step.

### Step 806

In crosstalk computation step 806, the crosstalk is computed for each eye or stereoscopic image from the pair of brightness measurements taken at each measurement point, using EQ. 5A-B. In this computation, the measurements used to compute the crosstalk for each eye or image bear no relationship with each other, i.e., measurements used for computing crosstalk_{R→L}(i,j) in EQ. 5A are independent of the measurements for computing crosstalk_{L→R}(i,j) in EQ. 5B. If right- and left-eye measurements from steps 803 and 805 are taken at different locations on screen 140, then an interpolation or extrapolation can be performed to obtain values for l_{R-L}, l_{L-L}, l_{L→R}, l_{R-R} all at each common screen location (i, j) of interest.

Since actual brightness measurements are available only at several measurement points, the values of crosstalk_{R→L}(i,j) and crosstalk_{L→R}(i,j) at other locations (i.e., where brightness measurements are not performed) are computed by interpolating or extrapolating from the crosstalk_{R→L}(i,j) and crosstalk_{L→R}(i,j) values at measured locations. Once computed, the complete set of values of crosstalk for all pixels of respective left- and right-eye images may be stored for use with each stereoscopic image pair. Alternatively, other approaches can also be used, for example, fitting a simple equation that uses L or R, i, and j as parameters to the crosstalk_{R→L}(i,j) and crosstalk_{L→R}(i,j) values obtained from the brightness measurements; or computing each crosstalk value for a denser, regular grid of points to subsequently provide a simpler interpolation at each pixel.

### Step 807

In compensation step 807, the expected or net crosstalk for each pixel of the respective stereoscopic images for the entire film or digital image file is calculated by using EQ. 7A-B, based on the crosstalk values obtained in step 806.

Similar to compensation step 708, the net crosstalk into each pixel of each eye is determined, which may include a blurring of the other-eye image (or blurring of t_{R/L}(i,j), a pixel's transmissivity), for example as discussed in conjunction with FIG. 6 but applying EQ. 1 or EQ. 2 to blur the other-eye image to accommodate the imprecision or uncertainty of alignment between the two projected images.

Likewise, to compensate for the net crosstalk from a given pixel of a first image, the density on film of the corresponding pixel in the other (or second) image is increased by an amount about corresponding to the increased brightness from the expected crosstalk. A crosstalk-compensated film or digital image file is produced by adjusting the density for the pixels according to the net crosstalk. For digital projection, the value of the corresponding pixel in the other (or second) image data is reduced by an amount about corresponding to the increased brightness from the expected crosstalk (whether handled a purely a luminance value or treated as separate RGB pixel values). The effect of too much or too little compensation in this step is the same as discussed above in conjunction with step 708.

### Steps 808-809

When a film print is produced in step 808 based on the crosstalk-compensated film negative and is projected in step 809, the resulting 3D presentation will have a crosstalk that is reduced or eliminated compared to the original film without crosstalk-compensation. Similarly, a stereoscopic digital image file that incorporates crosstalk compensation as described above will also result in a digital presentation with reduced crosstalk.

Process 800 concludes at step 810.

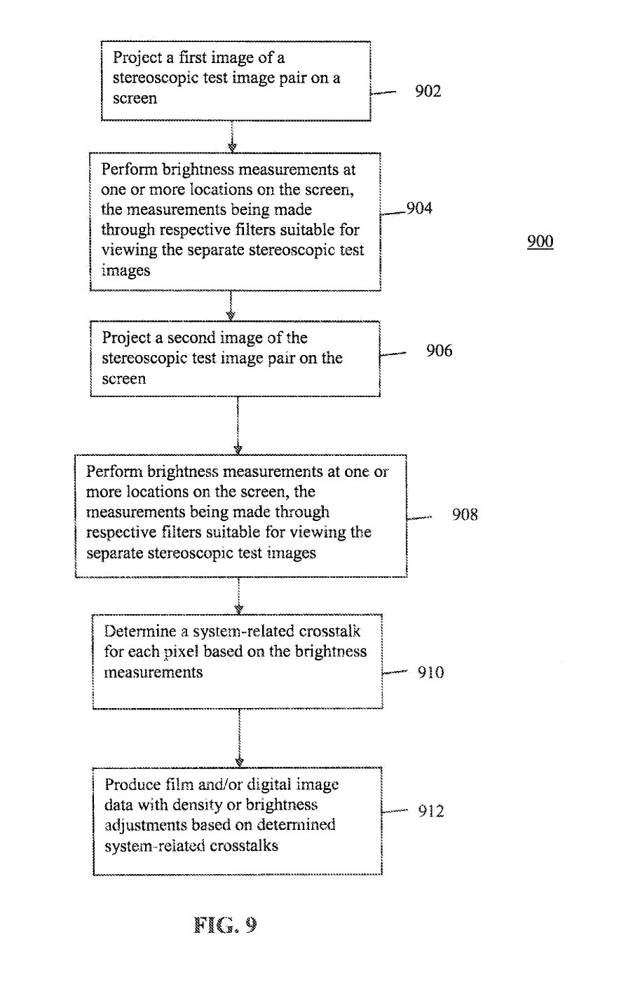

FIG. 9 illustrates another method 900 of crosstalk compensation for use in producing 3D film or stereoscopic digital image file with reduced crosstalk. The method compensates for crosstalk based on brightness measurements of projected stereoscopic test images (e.g., first and second images of a stereoscopic test image pair projected using opposite or orthogonal polarization orientations, respectively) in the presence of differential illumination or brightness between the stereoscopic images, i.e., crosstalk contributions due to unequal brightness in the left- and right-eye images.

### Step 902

In step 902, a first image of a stereoscopic test image pair is projected on a screen. In one embodiment, the first image can correspond to having the film projection system in open-gate mode. The image projection is configured so that there is no brightness contribution from the other (second) image of the stereoscopic pair, e.g., by blocking the projection of the second image, or having the second image as a black image. In one example, the first image has features similar to those of the test image discussed in connection with FIG. 7 or FIG. 8.

### Step 904

In step 904, brightness measurements are performed at one or more locations on the screen, with the measurements being done through respective filters suitable for viewing the separate first and second stereoscopic images. If the leakage is known to be uniform and symmetric, and the brightness is spatially uniform and the same for the left- and right-images, measurement at one location will suffice. However, in other situations, measurements should be done for at least two locations, e.g., one at the center and another one near an edge of the screen (e.g., top or bottom), to allow for interpolation of the data to other locations of the screen. Different arrangements can be used for the measurements, depending on the specific approaches, as described in connection with FIG. 7 or FIG. 8.

### Step 906

In step 906, a second image of the stereoscopic test image pair is projected on the screen, which can also correspond to having the film projection system in open gate mode. In this case, the projection is configured so that there is no brightness contribution from the first image, e.g., by blocking the projection of the one image, or having the first image as a black image. Again, the second image may have features similar to those of the test image discussed above in connection with FIG. 7 or FIG. 8.

### Step 908

In step 908, brightness measurements of the projected second test image are performed at one or more locations on the screen, with the measurements being done through respective filters suitable for viewing the separate stereoscopic images. Measurements are performed similar to those described in step 904, and different arrangements can be used for the measurements, depending on the specific approaches such as those described in connection with FIG. 7 or FIG. 8.

### Step 910

In step 910, crosstalk for each pixel is determined based on at least the above brightness measurements. Depending on the specific brightness measurements performed, the crosstalk for each pixel can also be determined using different approaches, as discussed in connection with FIG. 7 and FIG. 8. The resulting crosstalk value for each pixel of each image can be stored for use in producing a crosstalk-compensated film or digital image file.

### Step 912

In step 912, the crosstalk values determined from step 910 can be used for producing a crosstalk-compensated film negative or digital image data. For example, for any given pixel of an image in a film or digital file, the film negative or digital image file can be adjusted in density (for film) or brightness (for digital image) by an amount to offset the increased brightness corresponding to the net crosstalk at that pixel, similar to that described in connection with FIG. 7 and FIG. 8. (Since crosstalk from a first image would increase the brightness at a given pixel of the second image, the density increase for the second image on the film would effectively reduce the amount of light through that pixel, and thus, offset the net crosstalk.) One or more film prints can be made from the film negative or digital image file to produce crosstalk-compensated film prints for distribution or projection.

Although in the above examples, crosstalk compensation is provided for each pixel of an image, it is also possible to provide crosstalk compensation only for some pixels, e.g., in certain region(s), instead of the entire image space, or to provide compensation for only a portion (i.e., not all the frames) of a film or digital image file.

In another embodiment, it is possible to omit the actual measurements in steps 902-908, and estimate the relevant brightness terms for use in computing crosstalk for each pixel of the stereoscopic images, and produce a crosstalk-compensated film or digital image file by adjusting the density of each pixel based on the computed crosstalk.

### Digital Projection System

As discussed, the principles regarding crosstalk compensation for stereoscopic images are also applicable to certain implementations of digital 3D projection, such as systems that use separate lenses or optical components to project the right- and left-eye images of stereoscopic image pairs, in which differential distortions and crosstalks are likely to be present. Such systems may include single-projector or dual-projector systems, e.g., Christie 3D2P dual-projector system marketed by Christie Digital Systems USA, Inc., of Cypress, Calif., U.S.A., or Sony SRX-R220 4K single-projector system with a dual lens 3D adaptor such as the LKRL-A002, both marketed by Sony Electronics, Inc. of San Diego, Calif., U.S.A. In the single projector system, different physical portions of a common imager are projected onto the screen by separate projection lenses.

For example, a digital projector may incorporate an imager upon which a first region is used for the right-eye images and a second region is used for the left-eye images. In such an embodiment, the display of the stereoscopic pair will suffer the same problems of crosstalk described above for film because of the physical or performance-related limitations of one or more components encountered by the projecting light.

In such an embodiment, a crosstalk compensation can be applied (e.g., by a server) to the respective digital image data either as it is prepared for distribution to a player that will play out to the projector, or by the player itself (in advance or in real-time), by real-time computation as the images are transmitted to the projector, by real-time computation in the projector itself, or in real-time in the imaging electronics, or a combination thereof. Carrying out these corrections computationally in the server or with real-time processing can result in similar crosstalk reduction as described above for film.

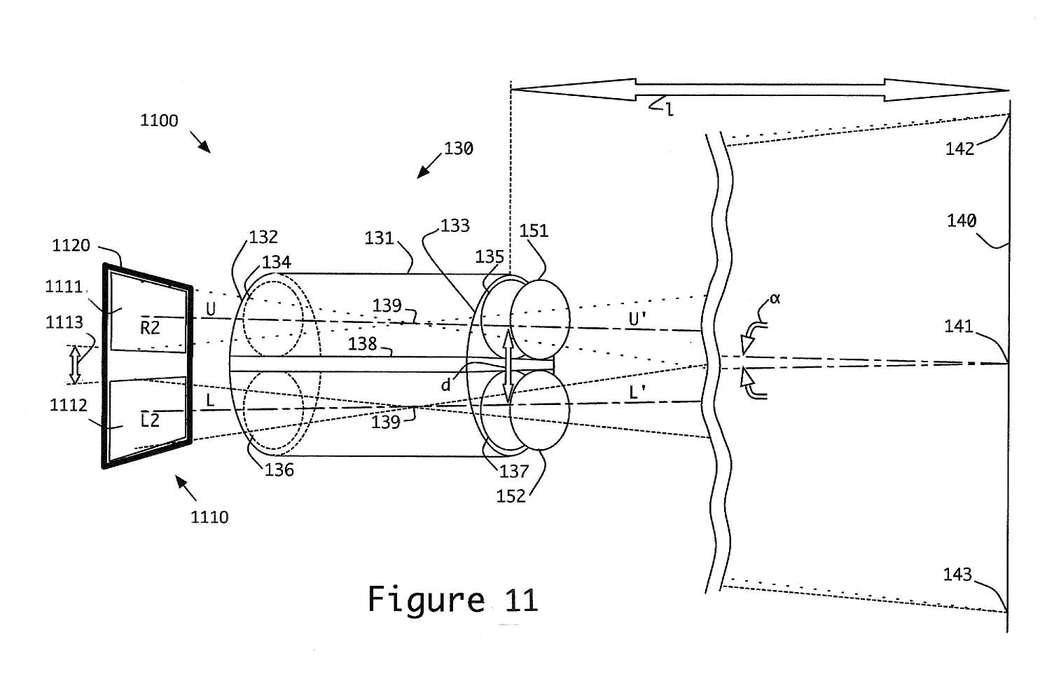

An example of a digital projector system 1100 is shown schematically in FIG. 11, which includes a digital projector 1110 and a dual-lens assembly 130 such as that used in the film projector of FIG. 1. In this case, the system 1100 is a single imager system, and only the imager 1120 is shown (e.g., color wheel and illuminator are omitted). Other systems can have three imagers (one each for the primary colors red, green and blue), and would have combiners that superimpose them optically, which can be considered as having a single three-color imager, or three separate monochrome imagers. In this context, the word “imager” can be used as a general reference to deformable mirrors display (DMD), liquid crystal on silicon (LCOS), light emitting diode (LED) matrix display, and so on. In other words, it refers to a unit, component, assembly or sub-system on which the image is formed by electronics for projection. In most cases, the light source or illuminator is separate or different from the imager, but in some cases, the imager can be emissive (include the light source), e.g., LED matrix. Popular imager technologies include micro-mirror arrays, such as those produce by Texas Instruments of Dallas, Tex., and liquid crystal modulators, such as the liquid crystal on silicon (LCOS) imagers produced by Sony Electronics.

The imager 1120 creates a dynamically alterable right-eye image 1111 and a corresponding left-eye image 1112. Similar to the configuration in FIG. 1, the right-eye image 1111 is projected by the top portion of the lens assembly 130 with encoding filter 151, and the left-eye image 1112 is projected by the bottom portion of the lens assembly 130 with encoding filter 152. A gap 1113, which separates images 1111 and 1112, may be an unused portion of imager 1120. The gap 1113 may be considerably smaller than the corresponding gap (e.g., intra-frame gap 113 in FIG. 1) in a 3D film, since the imager 1120 does not move or translate as a whole (unlike the physical advancement of a film print), but instead, remain stationary (except for tilting in different directions for mirrors in DMD), images 1111 and 1112 may be more stable.

Furthermore, since the lens or lens system 130 is less likely to be removed from the projector (e.g., as opposed to a film projector when film would be threaded or removed), there can be more precise alignment, including the use of a vane projecting from lens 130 toward imager 1120 and coplanar with septum 138.

In this example, only one imager 1120 is shown. Some color projectors have only a single imager with a color wheel or other dynamically switchable color filter (not shown) that spins in front of the single imager to allow it to dynamically display more than one color. While a red segment of the color wheel is between the imager and the lens, the imager modulates white light to display the red component of the image content. As the wheel or color filter progresses to green, the green component of the image content is displayed by the imager, and so on for each of the ROB primaries (red, green, blue) in the image.

FIG. 11 illustrates an imager that operates in a transmissive mode, i.e., light from an illuminator (not shown) passes through the imager as it would through a film. However, many popular imagers operate in a reflective mode, and light from the illuminator impinges on the front of the imager and is reflected off of the imager. In some cases (e.g., many micro-mirror arrays) this reflection is off-axis, that is, other than perpendicular to the plane of the imager, and in other cases (e.g., most liquid crystal based imagers), the axis of illumination and reflected light are substantially perpendicular to the plane of the imager.

In most non-transmissive embodiments, additional folding optics, relay lenses, beamsplitters, and other components (omitted in FIG. 11, for clarity) are needed to allow imager 1120 to receive illumination and for lens 130 to be able to project images 1111 and 1112 onto screen 140.

To compensate for crosstalk associated with a digital projection system, density adjustment or modification to a pixel of a first image would involve decreasing the brightness of that pixel by an amount about equal to crosstalk contribution (i.e., brightness increase) from the other image.

Although various aspects of the present invention have been discussed or illustrated in specific examples, it is understood that one or more features used in the invention can also be adapted for use in different combinations in various projection systems for film-based or digital 3D presentations. Thus, other embodiments applicable to both film-based and digital projection systems may involve variations of one or more method steps discussed above. As such, the appropriate scope of the invention is to be determined according to the claims, which follow.

1. A method for producing one of a crosstalk-compensated stereoscopic film or digital image data for use with a projection system, comprising:
(a) projecting a first image of a stereoscopic test image pair on a screen and measuring brightness at one or more locations on the screen;
(b) projecting a second image of the stereoscopic test image pair on the screen and measuring brightness at one or more locations on the screen;
(c) for each pixel of the stereoscopic test image pair, determining a crosstalk related to the projection system based at least on the brightness measurements from steps (a) and (b); and
(d) producing at least one of the stereoscopic film or digital image data, each with pixel adjustments based at least on the system-related crosstalk at each pixel of the stereoscopic test image pair.

2. The method of claim 1, wherein the first image is projected using a first polarization and the second image is projected using a second polarization that is orthogonal to the first polarization.

3. The method of claim 1, wherein the brightness measurement in step (a) includes:
(a1) measuring brightness of the projected first image as viewed through a first filter; and
(a2) measuring brightness of the projected first image as viewed through a second filter;
and the brightness measurement in step (b) includes:
(b1) measuring brightness of the projected second image as viewed through the first filter; and
(b2) measuring brightness of the projected second image as viewed through the second filter;
wherein the first filter is configured for passing primarily the first image, and the second filter is configured for passing primarily the second image.

4. The method of claim 3, wherein step (c) comprises:
for each pixel of the first image, computing the system-related crosstalk from the second image based on measurements from steps (a1) and (b1); and
for each pixel of the second image, computing the system-related crosstalk from the first image based on measurements from steps (a2) and (b2).

5. The method of claim 1, further comprising:
(e) determining at least one leakage value associated with the projection system; wherein the crosstalk in step (c) is further determined based on the at least one leakage value.

6. The method of claim 5, wherein the at least one leakage value corresponds to one of: a symmetric leakage value, or two asymmetric leakage values.

7. The method of claim 5, wherein the at least one leakage value is determined by one of computation or estimation.

8. The method of claim 1, wherein the measuring in step (a) corresponds to measuring brightness of the projected first image as viewed through a first filter configured for passing primarily the first image; and the measuring in step (b) corresponds to measuring brightness of the projected second image as viewed through a second filter configured for passing primarily the second image.

9. The method of claim 8, wherein step (c) comprises:
for each pixel of the first image, computing the system-related crosstalk from the second image by multiplying a first system-related uniform leakage by a ratio of the brightness measurement from step (b) to the brightness measurement from step (a); and
for each pixel of the second image, computing the system-related crosstalk from the first image by multiplying a second system-related uniform leakage by a ratio of the brightness measurement from step (a) to the brightness measurement from step (b).

10. The method of claim 9 wherein the first and second system-related leakages are equal.

11. The method of claim 1, wherein the pixel adjustment in step (d) further comprises:
for each pixel in each of first and second stereoscopic images of a stereoscopic film, determining a net crosstalk by multiplying the system-related crosstalk by a transmissivity for each pixel;
for each pixel of each first image of the stereoscopic film, increasing film density to compensate for the net crosstalk from a corresponding second image; and for each pixel of each second image of the stereoscopic film, increasing film density to compensate for the net crosstalk from a corresponding first image.

12. The method of claim 11, wherein the transmissivity for each pixel is related to content in each respective first and second images of the stereoscopic film.

13. The method of claim 12, wherein step (d) further comprises:
producing the stereoscopic film with crosstalk compensations for all stereoscopic image pairs based on increased density for each pixel of each image.

14. The method of claim 1, wherein the pixel adjustment in step (d) comprises:
for each pixel in each of first and second images of a digital image file, determining a net crosstalk by multiplying the system-related crosstalk by a value of each pixel;
for each pixel of each first image of the digital image file, decreasing pixel value to compensate for the net crosstalk from a corresponding second image; and for each pixel of each second image of the digital image file, decreasing pixel value to compensate for the net crosstalk from a corresponding first image.

15. The method of claim 14, wherein the transmissivity for each pixel is related to content in each respective first and second images of the stereoscopic digital image file.

16. The method of claim 15, wherein step (d) further comprises:
producing the stereoscopic digital image data with crosstalk compensations for all stereoscopic image pairs based on the decreased pixel value for each pixel of each image.

17. The method of claim 2, wherein the brightness measurement in step (a) includes:
(a1) measuring brightness of the projected first image as viewed through a first filter; and
(a2) measuring brightness of the projected first image as viewed through a second filter;
and the brightness measurement in step (b) includes:
(b1) measuring brightness of the projected second image as viewed through the first filter; and
(b2) measuring brightness of the projected second image as viewed through the second filter;
wherein the first filter is configured for passing primarily the first image, and the second filter is configured for passing primarily the second image.

18. The method of claim 6, wherein the at least one leakage value is determined by one of computation or estimation.

19. A system, comprising:
means for (a) projecting a first image of a stereoscopic test image pair on a screen and measuring brightness at one or more locations on the screen; (b) projecting a second image of the stereoscopic test image pair on the screen and measuring brightness at one or more locations on the screen;
means for determining a crosstalk for each pixel of the stereoscopic test image pair, the crosstalk being related to a projection system and determined based at least on the brightness measurements from steps (a) and (b); and
means for applying a crosstalk compensation to produce at least one of the stereoscopic film or digital image data, each with pixel adjustments based at least on the system-related crosstalk at each pixel of the stereoscopic test image pair.
